(19) United States
(12) Patent Application Publication
(10) Pub. No.: US 2024/0294704 A1
(43) Pub. Date: Sep. 5, 2024

(54) COPOLYMERS AND DEGRADABLE PLASTICS INCLUDING SALICYLATES

(71) Applicant: Regents of the University of Minnesota, Minneapolis, MN (US)

(72) Inventors: Christopher J. Ellison, Eden Prairie, MN (US); Marc Andrew Hillmyer, Minneapolis, MN (US); Hee Joong Kim, Minneapolis, MN (US)

(21) Appl. No.: 18/573,327

(22) PCT Filed: Jun. 21, 2022
(86) PCT No.: PCT/US2022/034301

§ 371 Date: Dec. 21, 2023

Related U.S. Application Data
(60) Provisional application No. 63/212,803, filed on Jun. 21, 2021.

(51) Int. Cl. C08G 63/06; C08G 63/08; C08G 63/183; C08G 63/85

(52) U.S. Cl. CPC C08G 63/065; C08G 63/08; C08G 63/183; C08G 63/85

(57) ABSTRACT

Provided herein are copolymers with salicylic acid moieties in the backbone and degradable polyester copolymers.

### CROSS-REFERENCE TO RELATED APPLICATION

This application claims the benefit of U.S. Application Ser. No. 63/212,803 entitled “COPOLYMERS AND DEGRADABLE PLASTICS INCLUDING SALICYLATES” filed Jun. 21, 2021, which is incorporated by reference herein in its entirety.

### TECHNICAL FIELD

This disclosure relates to copolymers with salicylic acid moieties in the backbone and degradable polyester copolymers.

### BACKGROUND

Some polymers labeled as degradable have limitations on their applications and/or degradability. For example, PLA must be exposed to elevated temperature, high humidity, and high microorganism concentrations in industrial composting facilities to induce hydrolytic degradation over reasonable time frames, and it is not readily degradable in natural environments or home compost. Other polymers, such as poly(hydroxyalkanoates), poly(γ-butyrolactone) (PBL), PBL with a trans-ring fusion, silyl-ether based polyolefins, and polyolefins with fused cyclic structures, are typically derived from fossil resources, require complicated monomer/polymer/catalysts synthesis steps, show limited copolymerization efficiency, and display limited degradability.

### SUMMARY

This disclosure describes a copolymer and methods for preparing said copolymer. Provided herein are methods of synthesizing a copolymer. The methods include combining a polyester with an aromatic ester having an electron-withdrawing moiety or an electron-donating moiety to yield a mixture, and transesterifying the aromatic ester and the polyester in the mixture in the presence of a catalyst, thereby inserting at least a portion of the aromatic ester into the polyester backbone to yield the copolymer.

Also provided herein are copolymers. The copolymers can include a polyester; and aromatic ester moieties, each having an aryloxy group, inserted along the backbone of the polyester.

Although the disclosed concepts include those defined in the attached claims, it should be understood that the concepts can also be defined in accordance with the following embodiments.

In addition to the embodiments of the attached claims and the embodiments, described below, the following numbered embodiments are also innovative.

Embodiment 1 is a method of synthesizing a copolymer, the method comprising: combining a polyester with an aromatic ester comprising an electron-withdrawing moiety or an electron-donating moiety to yield a mixture; and transesterifying the aromatic ester and the polyester in the mixture in the presence of a catalyst, thereby inserting at least a portion of the aromatic ester into the polyester backbone to yield the copolymer.

Embodiment 2 is the method of embodiment 1, wherein the polyester comprises a poly(lactic acid), a poly(caprolactone), or a poly(ethylene terephthalate).

Embodiment 3 is the method of embodiments 1 or 2, wherein the aromatic ester comprises a salicylate moiety.

Embodiment 4 is the method of any one of embodiments 1-3, wherein the aromatic ester comprises one or more of salicylic methyl glycolide (SMG), poly(SMG), salicylic acid, a linear polysalicylate, a cyclic salicylate, and a cyclic polysalicylate.

Embodiment 5 is the method of any one of embodiments 1-4, wherein the catalyst comprises tin.

Embodiment 6 is the method of embodiment 5, wherein the catalyst comprises n-octyltin oxide or stannous octoate.

Embodiment 7 is the method of any one of embodiments 1-6, wherein the mixture is a melt.

Embodiment 8 is the method of any one of embodiments 1-7, wherein the mixture comprises a solvent.

Embodiment 9 is the method of any one of embodiments 1-8, comprising heating the mixture.

Embodiment 10 is the method of embodiment 9, wherein heating the mixture occurs in a twin screw microcompounder.

Embodiment 11 is the method of any one of embodiments 1-10, wherein the copolymer comprises 0.1 mol % to 50 mol % of salicylate moieties.

Embodiment 12 is a copolymer comprising a polyester; and aromatic ester moieties, each having an aryloxy group, inserted along the backbone of the polyester.

Embodiment 13 is the copolymer of embodiment 12, wherein the aromatic ester moieties comprise salicylate moieties.

Embodiment 14 is the copolymer of embodiments 12 or 13, wherein the polyester comprises a poly(lactic acid), a poly(caprolactone), or a poly(ethylene terephthalate).

Embodiment 15 is the copolymer of embodiment 14, wherein the polyester comprises a poly(lactic acid), and the copolymer is a poly(lactic acid-stat-salicylic acid) represented by the formula:

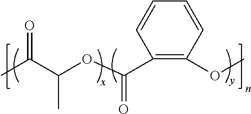

wherein x, y, and n are integers selected such that:
the copolymer comprises 50.5 mol % to 99.5 mol % of the moiety indicated by x and 0.5 mol % to 49.5 mol % of the moiety indicated by y, and
a molecular weight of the copolymer is in a range between 10,000 kg/mol and 200,000 kg/mol.

Embodiment 16 is the copolymer of embodiments 14 or 15, wherein the polyester comprises a poly(caprolactone), and the copolymer is a poly(caprolactone-stat-lactic acid-stat-salicylic acid) represented by the formula:

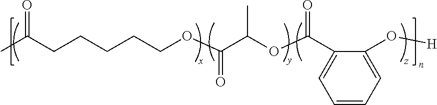

wherein x, y, z, and n are integers selected such that:
the copolymer comprises 0.1 mol % to 99 mol % of the moiety indicated by x, 0.5 mol % to 49.95 mol % of the moiety indicated by y, and 0.5 mol % to 49.95 mol % of the moiety indicated by z, and
a molecular weight of the copolymer is in a range between 10,000 kg/mol and 100,000 kg/mol.

Embodiment 17 is the copolymer of any one of embodiments 14-16, wherein the polyester comprises a poly(ethylene terephthalate), and the copolymer is a poly(ethylene glycol-stat-terephthalate-stat-cyclohexanedimethanol-stat-lactic acid-stat-salicylic acid) represented by the formula:

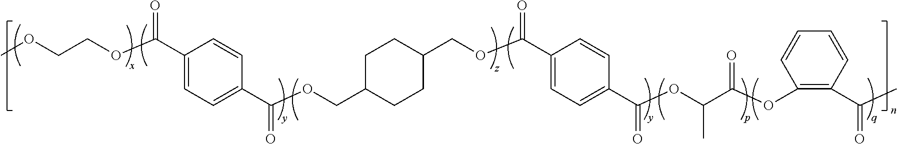

wherein x, y, z, p, q, and n are integers selected such that:
the copolymer comprises 0.1 mol % to 99 mol % of the moiety indicated by y, 0.1 mol % to 99 mol % of the moiety indicated by z, and 0.5 mol % to 49.95 mol % of the moiety indicated by p, 0.5 mol % to 49.95 mol % of the moiety indicated by q, and y=x+z, and
a molecular weight of the copolymer is in a range between 10,000 kg/mol and 50,000 kg/mol.

Embodiment 18 is the copolymer of any one of embodiments 13-17, wherein the copolymer comprises 0.1 mol % to 50 mol % of the salicylate moieties.

Embodiment 19 is the copolymer of any one of embodiments 12-18, wherein the copolymer undergoes backbone hydrolysis in aqueous solutions.

Embodiment 20 is the copolymer of embodiment 19, wherein the aromatic ester moieties facilitate the backbone hydrolysis.

Embodiment 21 is the copolymer of any one of embodiments 12-20, wherein the aromatic ester moieties are distributed throughout the backbone of the polyester.

Embodiment 22 is the copolymer of embodiment 21, wherein the degree of randomness R of the copolymer is between 0 and 2.

### BRIEF DESCRIPTION OF DRAWINGS

FIG. 1 shows synthetic pathways to produce poly(lactic acid-random-salicylic acid) (PLS).

FIG. 2 shows 1H NMR spectra corresponding to methine proton region with time upon three different routes for synthesis of PLS25 (R=degree of randomness).

FIGS. 3A-3D show properties of the synthesized polymers, including DSC data (2^{nd} heating, 10° C. min⁻¹), TGA data (under N₂, 10° C. min⁻¹), representative tensile testing data (ASTM D1708), and O₂ permeabilities, respectively.

FIGS. 4A-4C show mass loss profiles of polymers under the hydrolytic degradation conditions at 50° C. in 1 M PBS (pH 7.4), seawater (pH 8.1), and 0.1 M NaOH (aq.), respectively. FIGS. 4D-4E show plausible facilitated degradation mechanisms of PLS by salicylate sequence under basic and acidic (autocatalysis) conditions, respectively.

FIGS. 5A-5B show graphs of a ring-opening transesterification copolymerization of SMG and lactide in toluene at 110° C., [SMG]₀=2.0 M, [lactide]₀=1.0 M, [Sn(Oct)₂]₀=0.01 M, [BDM]₀=0.01 M, wherein (A) Time vs conversion plot and (B) kinetic data plot at [SMG]_{eq}≈[lactide]_{eq}≈0.015 M. Conversion was determined by ¹H NMR spectroscopy of the aliquots at each time point (500 MHz, CDCl₃).

FIGS. 6A-6C show (a) ¹³C NMR spectra (500 MHz, CDCl₃) of the synthesized polymers (target salicylate content, 25 mol %) and PLA corresponding to carbonyl carbons and (b) expanded section, and (c) ¹³C NMR spectrum of the lab-synthesized PLA corresponding to carbonyl carbons. Reaction times for routes A, B, and C are 12, 20, and 20 h, respectively. Red arrows in (b) indicate the statistically distributed microstructure of S and L units.

FIGS. 7A-7C show ¹³C NMR spectra (500 MHz, CDCl₃) of the synthesized polymers (target salicylate content, 25 mol %) and PLA corresponding to (a) α-, and (b) β-carbons. (c) ¹³C NMR spectrum of the lab-synthesized PLA corresponding to α- and β-carbons. Reaction times for routes A, B, and C are 12, 20, and 20 h, respectively. Red arrows indicate the statistically distributed microstructure of S and L units.

FIG. 8 shows a differential scanning calorimetry (DSC) graph (2nd heating, 10° C. min⁻¹) of the (co)polymers synthesized through Route A shown in FIG. 1.

FIG. 9 are size exclusion chromatography (SEC) chromatograms of the polymers as labeled in FIG. 1.

FIG. 10 is a reaction scheme of plausible in-situ polymerization-transesterification reactions.

FIGS. 11A-11C shows (A) Photographs of commercial PLA pellets and re-precipitated/dried the commercial PLA samples; (B) Effect of pre-drying of the PLA on molar mass and the relationship between molar mass and reaction time; and (C) Plausible fragmentation of PLA by water upon transesterification reactions.

FIGS. 12A-12B shows (A) Unproductive Sn-salicylate complex and (B) plausible Sn-salicylate complex upon the transesterification reactions in this study.

FIGS. 13A-13B show (A) a reaction scheme of intra-transesterification reaction of P(SMG-blocky-lactic acid) that synthesized through route A (target salicylate content, 25 mol %) of FIG. 1; (B) 1H NMR spectrum corresponding to methine proton region; and (C) SEC chromatogram (in THF).

FIGS. 14A-14B shows (A) a reaction scheme of in-situ polymerization-transesterification of PSMG and lactide (target salicylate content, 25 mol %); and (B) ¹H NMR spectrum corresponding to methine proton region and (c) SEC chromatogram (in THF).

FIG. 15 is a thermogravimetric analysis (TGA) data (under air, 10° C. min⁻¹) of various polymers of the disclosure.

FIGS. 16A-16D shows stress-strain curves of various polymers disclosed herein. Tensile testing was performed at room temperature with a strain rate of 5 mm min⁻¹. The break points are indicated by x.

FIGS. 17A-17D shows downstream pressure versus time plots for O₂ permeability measurements of various polymers of the disclosure. O₂ permeation measurements were performed with three different upstream pressures (45, 145, and 245 psi).

FIG. 18 shows mass profiles of polymers of the disclosure in PBS at 40° C.

FIG. 19 shows a graph of monthly solar radiation quantities on the experimental place (Minneapolis, Minnesota, USA) during the experimental period. Data was obtained from the Minnesota Solar Suitability Analysis.

FIGS. 20A-20B shows (A) mass profiles of polymers under the hydrolytic degradation conditions at room temperature (23-27° C.) in PBS exposing samples to natural sunlight and (B) expanded section.

FIGS. 21A-21B shows (A) Arrhenius plots of days for swelling vs temperature for PLS25 and PLA in PBS and (B) Prediction for complete mass loss occurrence of PLS25 and PLA in PBS at room temperature.

FIG. 22 shows a UV-Vis spectra of various polymers of the disclosure (0.1 wt % in THF).

FIG. 23 shows and 1H NMR spectra (500 MHZ, D₂O) of the supernatant in the degradation experiment solution (from 0.1 M NaOH) of PLSs.

FIG. 24 shows mass profiles of a polymer of the disclosure under the hydrolytic degradation conditions at 50° C. in PBS and 0.1 M NaOH solution.

FIG. 25 shows the synthesis of PCL and PETg with salicylate sequences through in-situ polymerization and transesterification reactions (Route B of FIG. 1).

FIGS. 26A-26D shows (A) 1H NMR spectrum (500 MHz, CDCl₃) of PCL and PCLS. Expanded sections corresponding to (B) methine, (C) ¿-proton, and (D) α-proton regions.

FIG. 27 shows an 1H NMR spectrum (500 MHZ, CDCl₃+TFA-d, 4:1 wt.) of PETg.

FIGS. 28A-28D shows (A) 1H NMR spectrum (500 MHZ, CDCl₃+TFA-d, 4:1 wt.) of PETCLS; and expanded sections corresponding to (B) aromatic, (C) methine, and (D) methylene regions.

FIG. 29 shows SEC chromatograms of PCL and PCLS (in THF).

FIG. 30 shows SEC chromatograms of PETg and PETCLS (in hexfluoroisopropanol).

FIGS. 31A-31B shows (A) DSC data of PCL and PCLS (2^{nd} heating, 10° C. min⁻¹) and (B) 1st derivative graphs of PCL and PCLS corresponding to glass transition region.

FIG. 32 shows DSC data of PETg and PETCLS (2^{nd} heating, 10° C. min⁻¹).

FIGS. 33A-33B shows mass loss profiles of polymers of the disclosure under the hydrolytic degradation conditions at 50° C. in 2 M NaOH (aq.); (A) PCL and PCLS, and (B) PETg and PECTLS.

FIG. 34 shows a 1H NMR spectrum (500 MHZ, D₂O) of the supernatant in the degradation experiment solution of PCLS.

FIG. 35 shows a 1H NMR spectrum (500 MHZ, D₂O) of the supernatant in the degradation experiment solution of PETCLS (at 100 days).

FIGS. 36A-36C shows (A) Insoluble solid dispersion upon degradation of PETCLS; (B) plausible chemical structures (n=0-3) and 1H NMR spectrum (500 MHz, CDCl₃ with 20 wt % TFA-d, 45° C.) and (C) MALDI-TOF data of the insoluble powders. 2-[(2E)-3-(4-tert-Butylphenyl)-2-methyl-2-propenylidene]malononitrile (DCTB) was used as a matrix in MALDI-TOF analysis.

### DETAILED DESCRIPTION

Synthesizing a copolymer includes combining a polyester with an aromatic ester having an electron-withdrawing moiety or an electron-donating moiety to yield a mixture, and transesterifying the aromatic ester and the polyester in the mixture in the presence of a catalyst, thereby inserting at least a portion of the aromatic ester into the polyester backbone to yield the copolymer. The mixture can be in the form of a melt or a solution. In some cases, the mixture is heated. In one example, the mixture is heated in a twin screw microcompounder. The polyester can be a poly(lactic acid), a poly(caprolactone), or a poly(ethylene terephthalate). In some cases, the aromatic ester includes a salicylate moiety. The catalyst can include tin (e.g., n-octyltin oxide or stannous octoate).

In some cases, the aromatic ester includes a salicylate moiety. For example, the aromatic ester can be one or more of salicylic methyl glycolide (SMG), poly(SMG), salicylic acid, a linear polysalicylate, a cyclic salicylate, or a cyclic polysalicylate. An example of a linear polysalicylate and its preparation can be found in Akkad et al., Macromol. Rapid Commun., 2018, 39, 1800182. Examples of cyclic salicylates can be found inEight- and higher-membered ring compounds. Part II. Di-, tri-, tetra-, and hexa-salicylides-Wilson Baker, W. D. Ollis and T. S. Zealley—J. Chem. Soc., 1951, 201-208. An example of a cyclic polysalicylate can be found in Luis et al., J. Org. Chem., 1990, 55, 3808-3812.

The resulting copolymer includes a polyester and aromatic ester moieties, each having an aryloxy group, inserted along the backbone of the polyester. The copolymer can include 0.1 mol % to 50 mol % of the aromatic ester moieties. The aromatic ester moieties are distributed along the backbone of the polyester such that a degree of randomness R of the copolymer, as defined herein, is between 0 and 2.

In one example, the polyester is a poly(lactic acid), and the copolymer is a poly(lactic acid-stat-salicylic acid) represented by the formula:

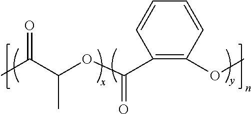

where x, y, and n are integers selected such that the copolymer comprises 0.5 mol % to 49.5 mol % of the moiety indicated by x and 0.5 mol % to 49.5 mol % of the moiety indicated by y, and a molecular weight of the copolymer is in a range between 10,000 kg/mol and 200,000 kg/mol.

In another example, the polyester is a poly(caprolactone), and the copolymer is a poly(caprolactone-stat-lactic acid-stat-salicylic acid) represented by the formula:

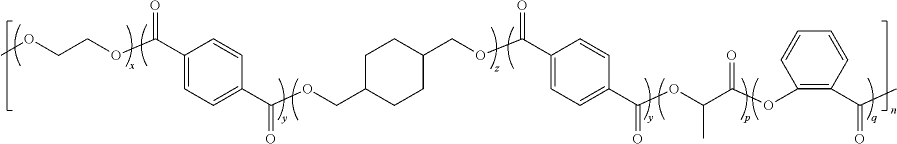

where x, y, z, and n are integers selected such that the copolymer comprises 0.1 mol % to 99 mol % of the moiety indicated by x, 0.5 mol % to 49.5 mol % of the moiety indicated by y, and 0.5 mol % to 49.5 mol % of the moiety indicated by z, and a molecular weight of the copolymer is in a range between 10,000 kg/mol and 100,000 kg/mol.

In yet another example, the polyester is a poly(ethylene terephthalate), and the copolymer is a poly(ethylene glycol-stat-terephthalate-stat-cyclohexanedimethanol-stat-lactic acid-stat-salicylic acid) represented by the formula:

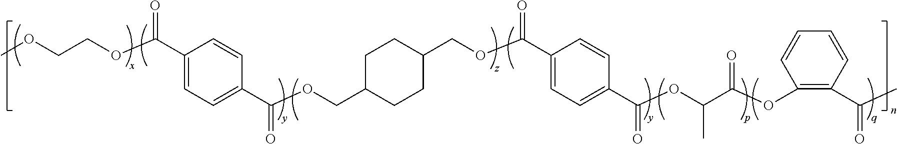

where x, y, z, p, q, and n are integers selected such that the copolymer comprises 0.1 mol % to 99 mol % of the moiety indicated by y, 0.1 mol % to 99 mol % of the moiety indicated by z, and 0.5 mol % to 49.5 mol % of the moiety indicated by p, 0.5 mol % to 49.5 mol % of the moiety indicated by q, and y=x+z, and a molecular weight of the copolymer is in a range between 10,000 kg/mol and 50,000 kg/mol.

The copolymer undergoes backbone hydrolysis in aqueous solutions, with the aromatic ester moieties facilitating the backbone hydrolysis.

Some embodiments includes the synthesis of polyester copolymers containing salicylate moieties distributed throughout the polymer backbone, as well as the resulting polyester-salicylic acid copolymers and degradable plastics formed of the copolymers. The copolymer is synthesized by transesterification reactions, including (i) in-situ polymerization-transesterification between an aromatic ester including a salicylate moiety and a polyester to insert salicylate moieties into the polyester backbone; and (ii) intermolecular transesterification between an oligomer or polymer of the salicylate moieties and the polyester to insert salicylate moieties into the polyester backbone. In one example, the polyester is polylactic acid and the copolymer is a poly(lactic acid-salicylic acid) (PLS). The PLS shows thermal, mechanical, and gas permeation properties comparable to those of PLA, and enhanced hydrolytic degradability in a variety of aqueous environments, including aqueous buffer, seawater, and alkaline solutions. Other examples include salicylic-acid-containing poly(caprolactone) (PCL) and poly(ethylene terephthalate) (PETg) copolymers. These copolymers also demonstrate enhanced degradation behavior in alkaline solutions. The synthetic method is scalable, and the copolymers can be obtained from the melt-processing of commercial polyesters using a twin-screw microcompounder.

### EXAMPLES

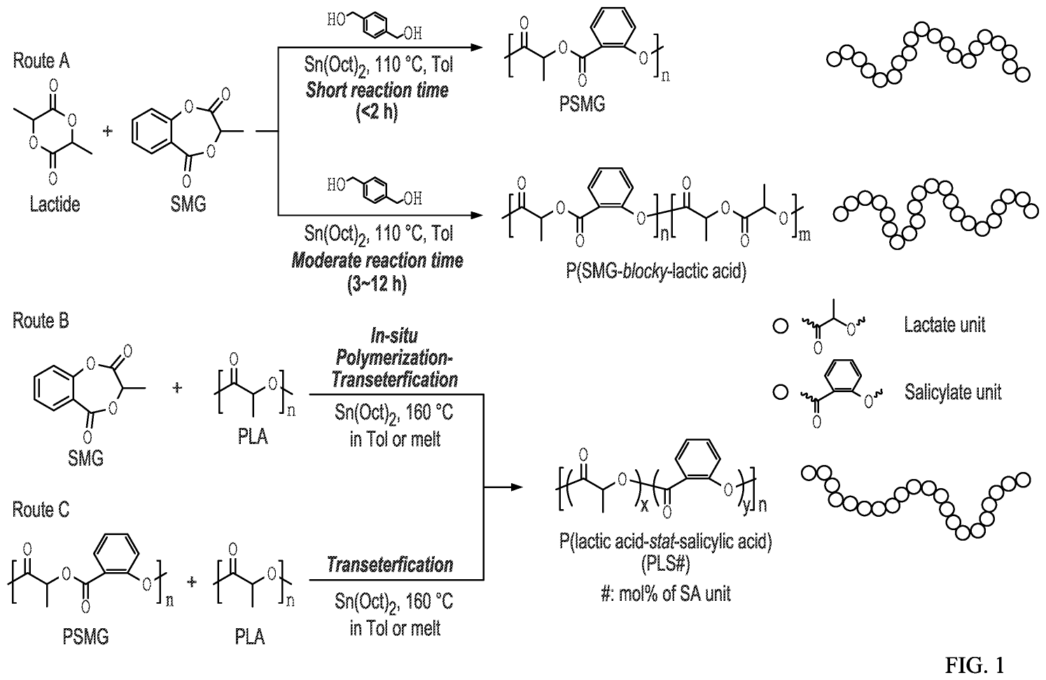

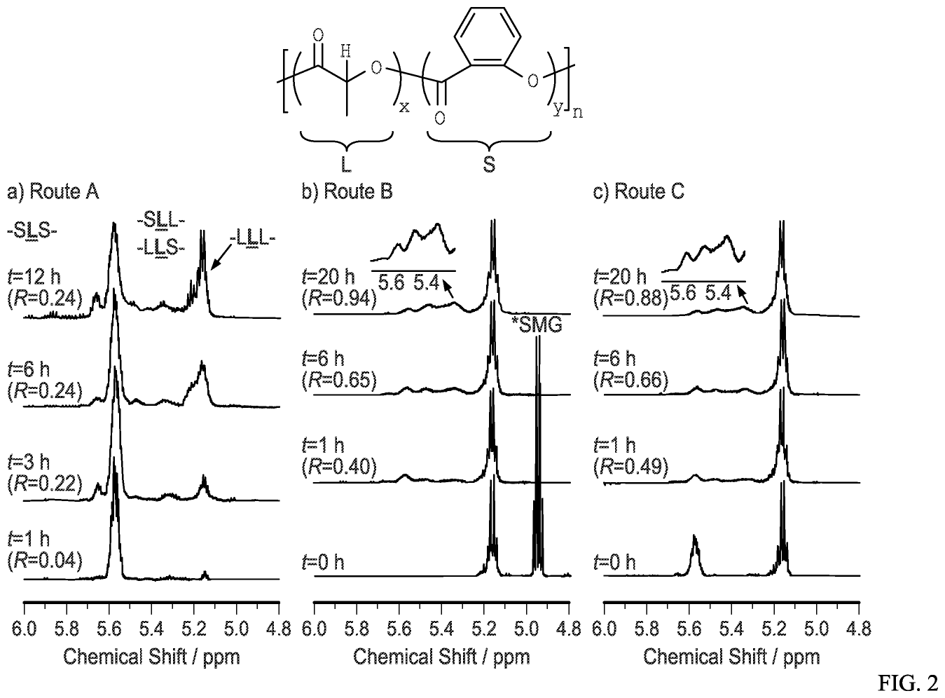

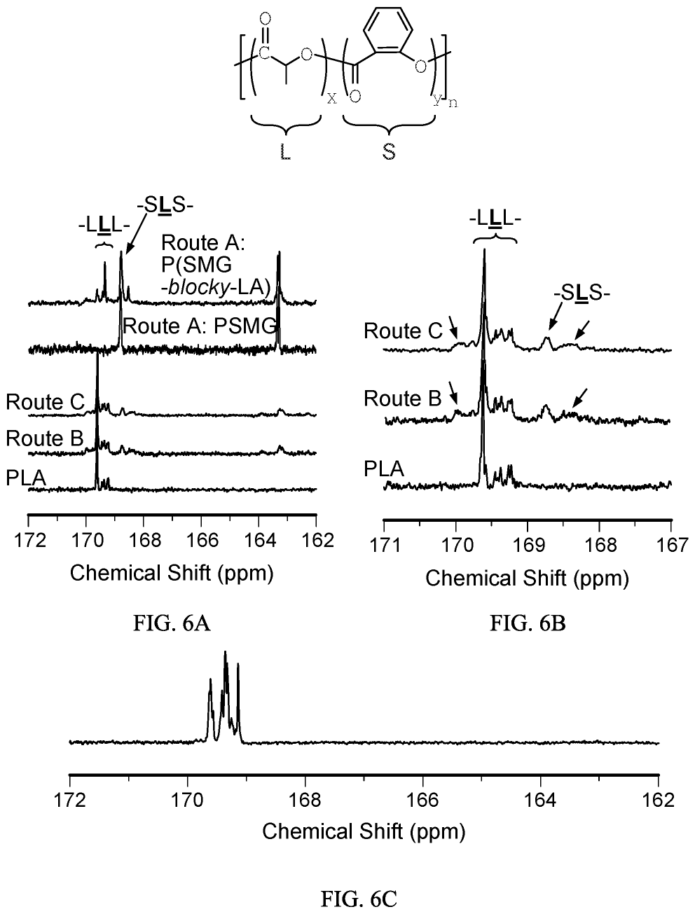

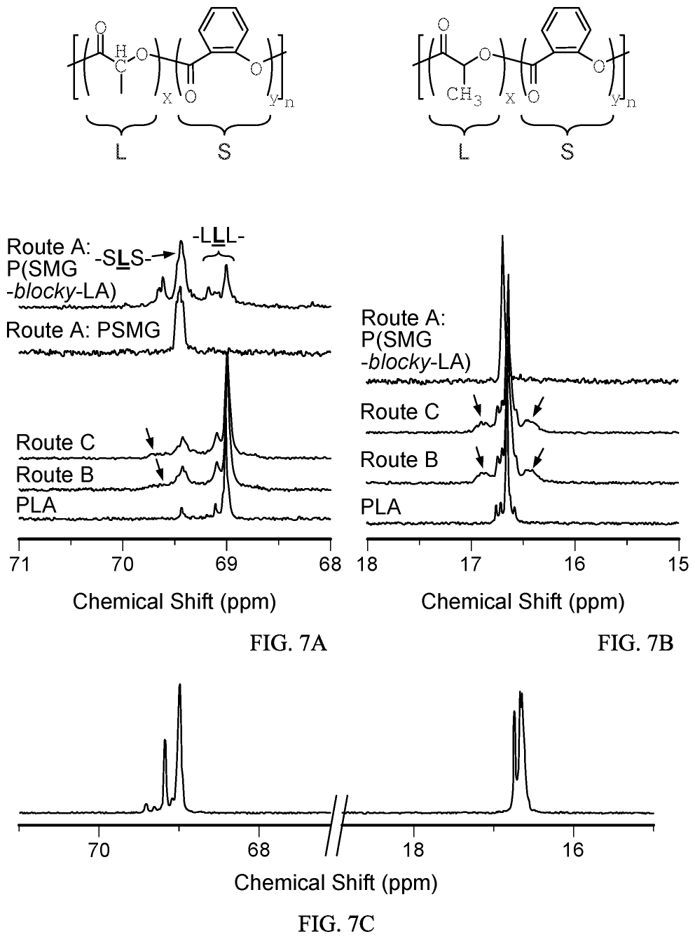

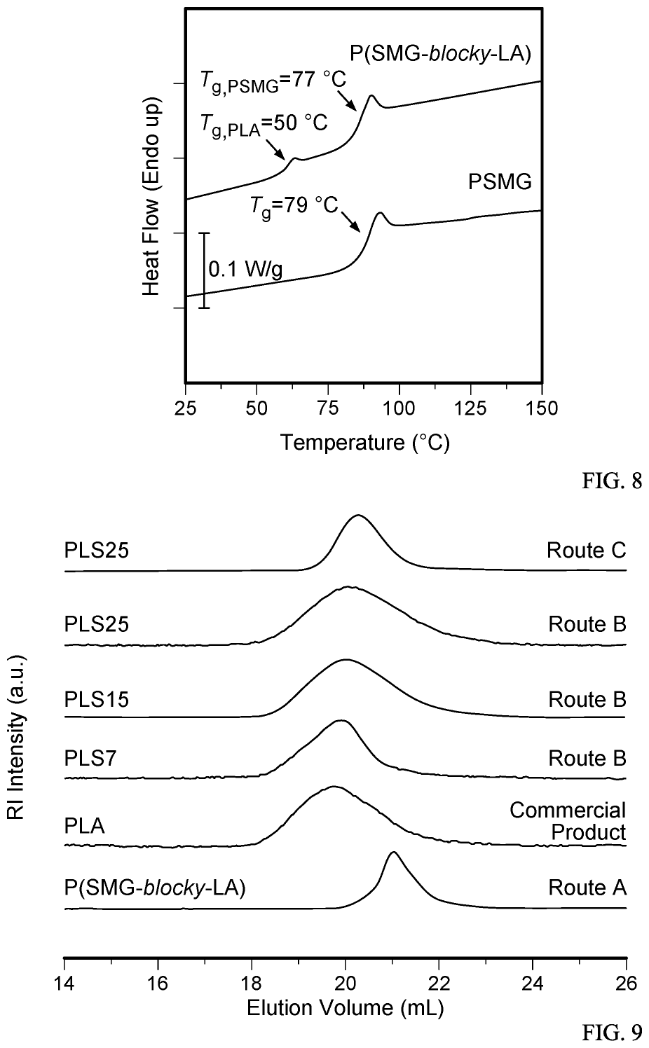

Polymer synthesis. Ring-opening transesterification copolymerization of lactide and salicylic methyl glycolide (SMG) (Route A) was carried out in presence of Sn(Oct)₂ (FIG. 1 and Entries 1-4 in Table 1). A reaction time of 2 h at 110° C. resulted in the production of poly(salicylic methyl glycolide) (PSMG) homopolymer with very little lactide incorporation, and a blocky polymer was produced with longer reaction times (3-12 h). The microstructure of the copolymer was investigated by 1H NMR spectroscopy (FIG. 2A), and both lactate (L) and salicylate (S) units were resolved to distinguish the L-L-L homosequence, L-L-S/S-L-L heterosequences, and a S-L-S alternating sequence. The S-L-S alternating signals were predominant at early stages. The L-L-L homosequence signals gradually increased over time with little increase in heterosequences, indicating blocky polymer formation. This result was in agreement with ¹³C NMR spectroscopy (FIGS. 6A-6C and 7A-7C), T_{g} analysis by differential scanning calorimetry (DSC) (FIG. 8), and molar mass analysis by size exclusive chromatography (SEC) (FIG. 9).

TABLE 1
Synthesis and characterization data of PLS

| | | L:S | Temperature | L:S | | | | |
|---|---|---|---|---|---|---|---|---|
| | | In feed | (° C.)/ | In polymer | | | | |
| Entry^{a} | Route | (mol %)^{b} | Time (h) | (mol %)^{c} | M_{n, SEC}^{d} | M_{w, SEC}^{d} | Ð^{d} | R^{e} |
| 1 | A | 75:25 | 110/1 | 52:48 | 39 | 45 | 1.2 | 0.04 |
| 2 | | | 110/3 | 56:44 | 42 | 49 | 1.2 | 0.22 |
| 3 | | | 110/6 | 66:34 | 45 | 55 | 1.2 | 0.24 |
| 4 | | | 110/12 | 69:31 | 66 | 80 | 1.2 | 0.24 |
| 5 | B | 75:25 | 160/1 | 75:25 | 96 | 113 | 1.2 | 0.40 |
| 6 | | | 160/6 | 75:25 | 91 | 110 | 1.2 | 0.65 |
| 7 | | | 160/20 | 75:25 | 87 | 109 | 1.3 | 0.94 |
| 8 | | 85:15 | 160/20 | 85:15 | 92 | 122 | 1.3 | 0.95 |
| 9 | | 90:10 | 160/20 | 93:7 | 94 | 120 | 1.3 | 0.96 |
| 10 | | 98:2 | 160/20 | 98:2 | 99 | 128 | 1.3 | 0.96 |
| 11 | C | 75:25 | 160/1 | 75:25 | 90 | 119 | 1.3 | 0.49 |
| 12 | | | 160/6 | 75:25 | 85 | 113 | 1.3 | 0.66 |
| 13 | | | 160/20 | 75:25 | 83 | 101 | 1.2 | 0.88 |
| 14 | | 85:15 | 160/20 | 85:15 | 85 | 106 | 1.2 | 0.87 |
| 15 | | 90:10 | 160/20 | 91:9 | 88 | 109 | 1.2 | 0.90 |
| 16^{f} | B | 75:25 | 160/3 | 75:25 | 72 | 88 | 1.2 | 0.85 |
| 17^{f} | C | 75:25 | 160/3 | 75:25 | 66 | 82 | 1.2 | 0.79 |

^{a}at [Sn(Oct)₂]₀ = 0.01M in toluene (overall mass concentration, 50-65 wt %) otherwise specified.
^{b}one SMG monomer contains one of each lactate (L) and salicylate (S) unit, lactide contains two L units. For example, in Route A, a mixture of lactide:SMG = 25:50 yields L:S = 75:25 in feed.
^{c}Determined by ¹H NMR spectroscopy.
^{d}Determined by THF-SEC (molar mass unit, kg mol⁻¹).
^{e}Degree of randomness, determined by ¹H NMR spectroscopy.
^{f}Reactions were performed in bulk using microcompounder at [DOTO]₀ = 0.02M.

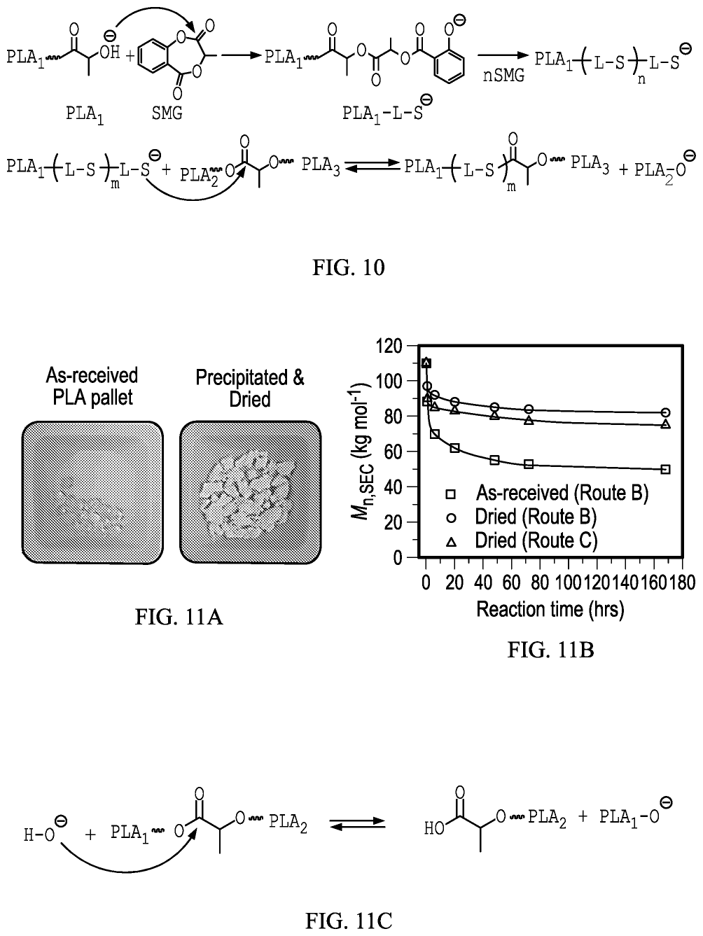

Salicylate moieties can be incorporated into the polyester backbone directly by transesterification at 160° C. (FIG. 1, FIG. 10 for plausible reactions): either in-situ polymerization-transesterification of SMG and PLA (Route B in FIG. 1, Entries 5-10 in Table 1) or intermolecular transesterification between PSMG and PLA (Route C in FIG. 1, Entries 11-15 in Table 1) using solution based processes. PLS # indicates the poly(lactic acid-stat-salicylic acid) containing #mol % of salicylate moieties. In the 1H NMR spectra for Route B, the SMG signals disappeared and S-L-S alternating sequences appeared after 1 h (FIG. 2B). The S-L-S signals then decreased with increasing L-L-S/S-L-L heterosequences signals over time, suggesting that rapid polymerization of SMG occurred early and was then followed by transesterification. 1H NMR spectra for Route C showed decrease of S-L-S alternating sequences and increase of L-L-S/S-L-L heterosequences upon reaction, indicating successful sequence exchange (FIG. 2C). Based on the 1H NMR data, the degree of randomness (R) was calculated, where R=0 for a block copolymer and R=1 for a completely random architecture. The R value increased to ≈0.9 through Routes B and C while plateauing at 0.24 in Route A, further suggesting that statistical distributions could be achieved through transesterification. The statistical distributions were further supported by ¹³C NMR spectroscopy (FIGS. 6A-6C and 7A-7C). The molar mass of the starting PLA (M_{n,SEC}=111 kg mol⁻¹, Ð=1.3) decreased to some extent (FIG. 9), for example, the molar mass of PLS25 through Route B and C was 87 and 83 kg mol⁻¹, respectively. This possibly originates from cyclic formation, transacylation, and/or chain fragmentation upon transesterifications.

In-situ polymerization-transesterification of SMG and PLA (Route B, Entries 5-7 in Table 1) and intermolecular transesterification between PSMG and PLA (Route C, Entries 11-13 in Table 1) were performed at 160° C. in presence of Sn(Oct)₂ to produce PLS25. ¹³C NMR spectroscopy results are consistent with the 1H NMR results. Broadening and new peak appearance were observed at the regions corresponding to carbonyl, α-, and β-carbons, suggesting the microstructures with statistical distribution (FIGS. 6A-6C and 7A-7C). In both 1H and ¹³C NMR spectra, the L-L-L homosequence resonances of the polymer synthesized through Route A were broader and/or more split than those of PLS synthesized through Routes B and C, although higher R values were achieved through Routes B and C as compared to Route A. This is due at least in part to differences in strereo-regularity. rac-Lactide was used in the copolymerization procedure (i.e., Route A), while commercial grade PLA with high L content (up to 88%) was used in transesterification procedures (i.e., Routes B and C). A series of PLS with lower salicylate content was synthesized by modulating [L]/[S] ratio in feed, indicating that the transesterification reactions are controllable at high conversion (Entries 8-10 and 14-15 in Table 1). For the synthesis of PLS10, salicylate content in the synthesized polymer was slightly lower than 10 mol %, which could be due to difficulties associated with accurately weighing the parent PLA polymer.

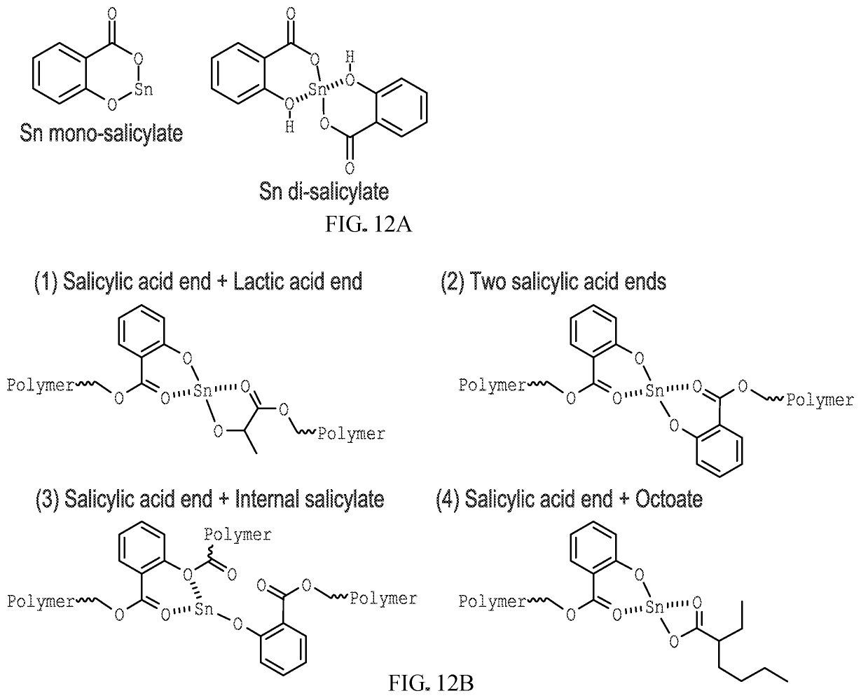

The molar mass of PLS synthesized by transesterifications (Routes B and C) was smaller than that of starting PLA (M_{n,SEC}=111 kg mol⁻¹, Ð=1.3) (FIG. 9), which may be due to the cyclic formation, transacylation, and/or chain fragmentation upon transesterification reactions. Molar mass exponentially decreased for ≈20 h and reached to a near plateau (FIGS. 11A-11C). Rapid decrease in molar mass at the early stage is presumably due to the impurities such as water in starting materials (i.e., PLA, SMG or PSMG) that can induce degradable transesterification reactions (e.g., chain fragmentation), competing with intended transesterification reactions. The production of PSMG oligomers initiated by water is another possible degradation pathway. Pre-drying of PLA is typically needed to minimize the decrease in molar mass (FIGS. 11A-11C). A near complete consumption of impurities may contribute to plateauing in molar mass. That is, when a transesterification reaction between two different polyesters is carried out, the molar mass of the resultant polymer reaches the average value of each polymer. Another hypothesis for plateauing in molar mass is that Sn(Oct)₂ catalyst is deactivated by the formation of a stable Sn-complex. When salicylic acid was used as a co-catalyst in the Sn(Oct)₂-catalyzed polymerization of L-lactide, reduction in molar mass and polymerization rate was observed due to the unproductive Sn-salicylate complex formation, (FIG. 12A). Presumably, similar Sn-salicylate complexes could be formed with salicylic acid (from monomer/polymer degradation), internal salicylate moieties, and polymer chain end during the transesterification reactions (FIG. 12B). After adding fresh Sn(Oct)₂ to a 7-day-old transesterification reaction (Route B), the molar mass decreased from M_{n,SEC}≈85 kg mol⁻¹ to M_{n,SEC}≈57 kg mol⁻¹ after 2 days. When the polymerization was carried out with SMG monomer, fresh Sn(Oct)₂, and hydroxy-telechelic PSMG as a macroinitiator, the reaction reached high monomer conversion and an increase in Mₙ was observed. In contrast, no increase in Mₙ was observed when the SMG monomer was added to the high conversion crude reaction system. This might indicate that Sn(Oct)₂ is partially deactivated by salicylic acid and/or salicylates.

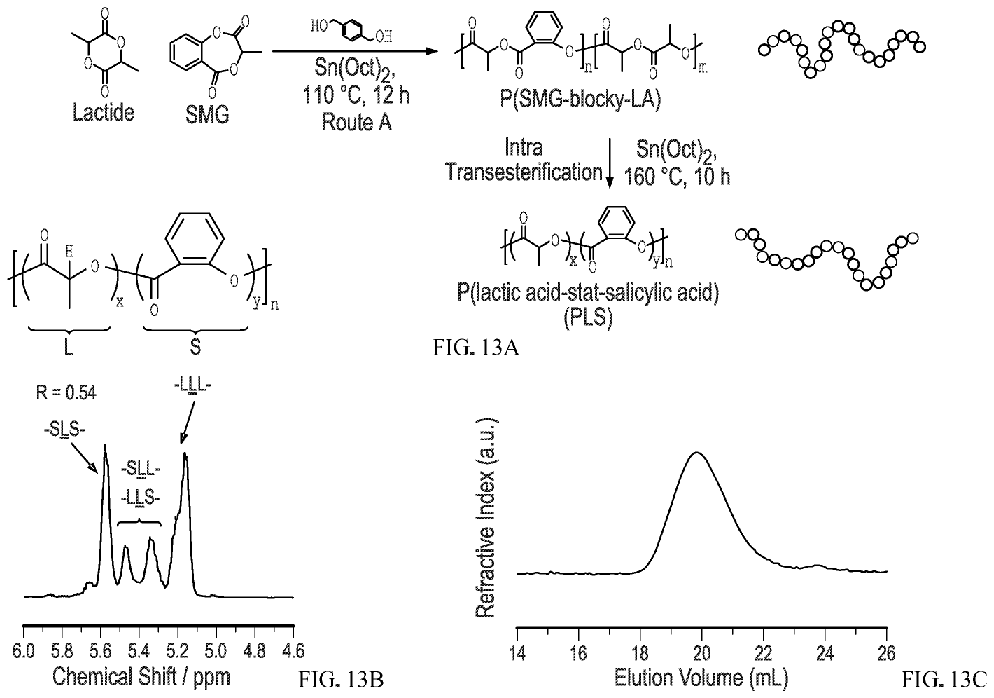

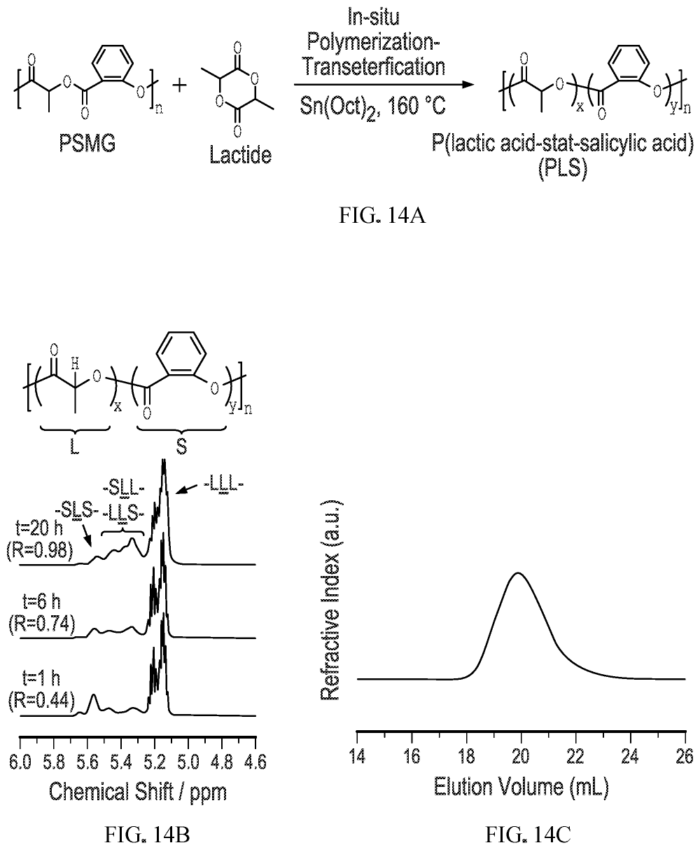

Additionally, a series of PLS was synthesized by the other types of transesterification reactions. Intramolecular transesterification of a blocky copolymer synthesized through Route A with Sn(Oct)₂ at 160° C. for 10 h produced statistical copolymer (R=0.54, FIGS. 13A-13B). in-situ polymerization-transesterification of lactide and PSMG is the other synthetic pathway to produce statistical copolymer (R=0.98, FIGS. 14A-14B). In contrast, a transesterification reaction between PLA and salicylic acid with Sn(Oct)₂ at 160° C. for 20 h resulted in a significant PLA degradation. When concentrated crude reaction solution was added dropwise into cold methanol, no precipitation was observed, presumably indicating that PLA degraded to lactic acid and/or low molar mass PLA oligomers that are soluble in methanol.

Both transesterification reactions (Routes B and C) were also carried out in melt using a twin screw microcompounder (160° C., 3 h). Through this bulk/scalable process, PLS with statistical distributions (R=0.79-0.85) was obtained with high SMG conversion (>99%) (Table 1, Entries 16-17). The transesterification in melt state showed comparable extent of reaction to that in solution even at shorter reaction times (3 h).

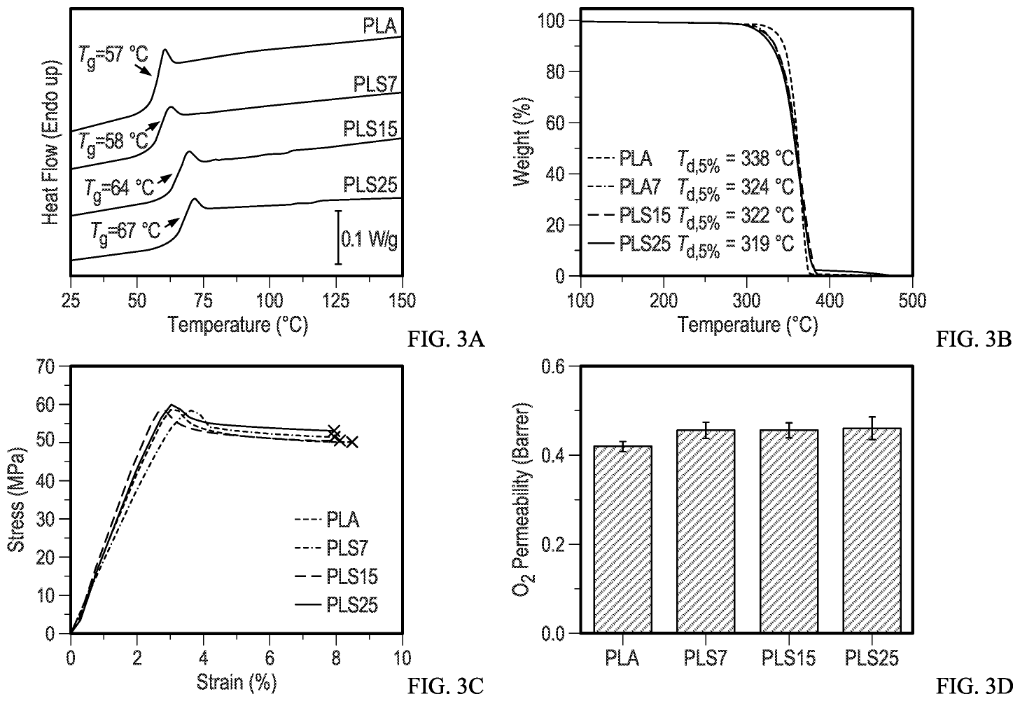

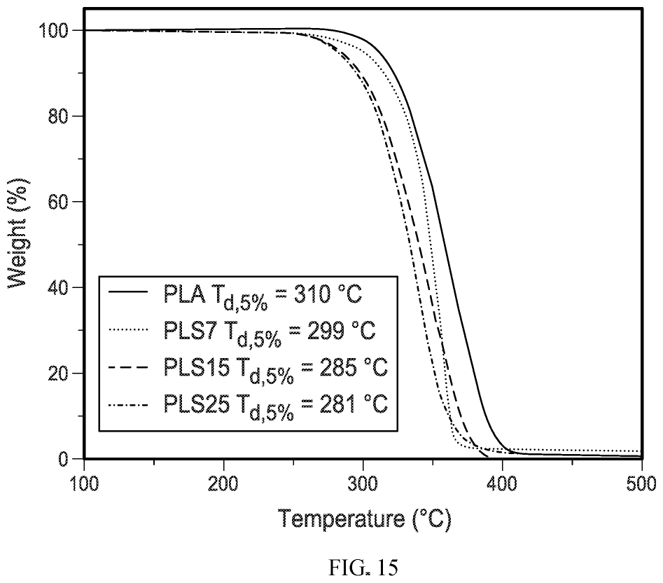

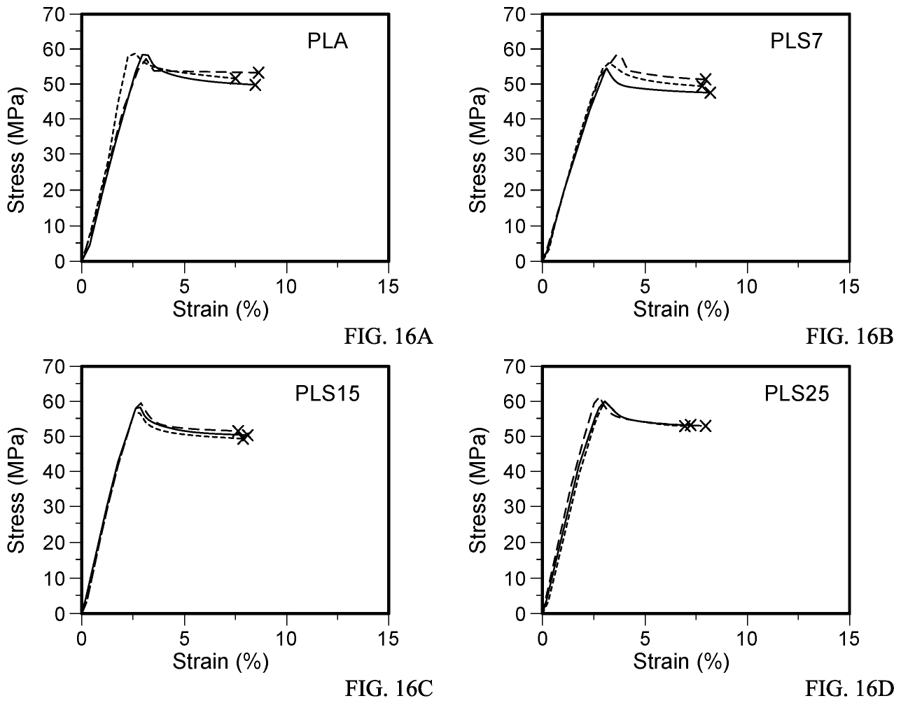

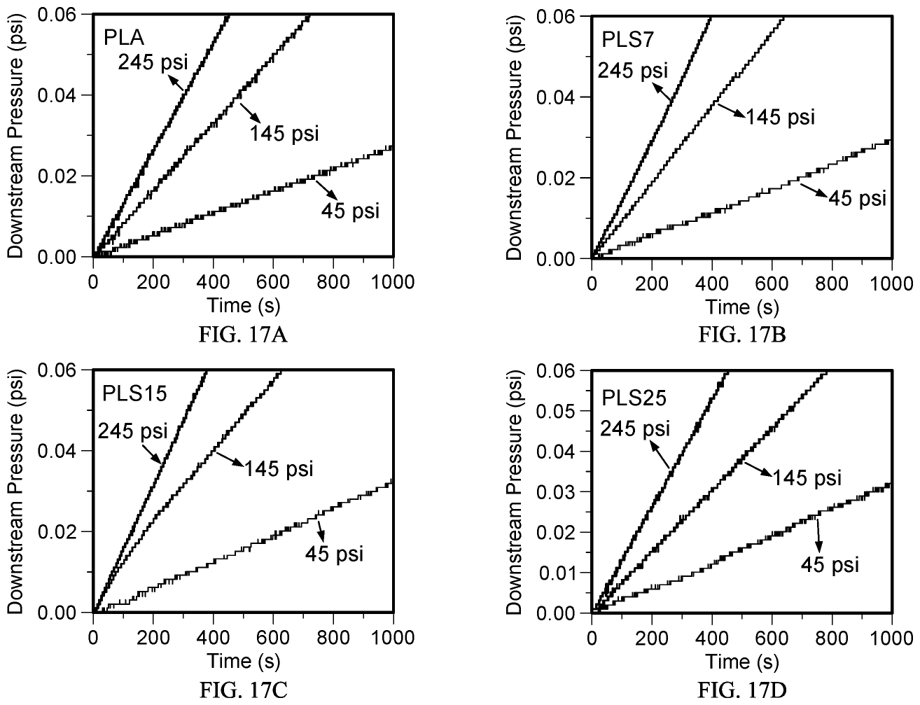

Copolymer properties. The thermal and mechanical properties of PLS samples were examined by DSC, thermogravimetric analysis (TGA), and tensile testing. PLS samples synthesized through Route B (Entries 7-9 in Table 1) were utilized because of their high molar masses and high degrees of randomness. PLS7 showed T_{g}=58° C., comparable to T_{g,PLA}=57° C. (FIG. 3A). The T_{g}s of PLS increased with increasing salicylate content (e.g., T_{g,PLS25}=67° C.), thus the modifications here actually increase the T_{g} of the product polyesters as compared to the parent PLA. All PLSs displayed T_{d,5%}≈320° C. (T_{d,5%}, defined by the temperature of 5% mass loss), comparable to T_{d,5%,PLA}=338° C. and other polyesters (e.g., T_{d,5%} of poly(γ-methyl caprolactone)≈350° C., under N₂), demonstrating that they are thermally robust (FIG. 3B, FIG. 15 for TGA data under air). The PLS displayed tensile strength of σ_{B}≈58 MPa, elastic modulus of E≈2.2 GPa, and elongation at break of ε_{b}≈7.9% (FIG. 3C and FIGS. 16A-16D, Table 2), which are all comparable to PLA. For comparative purposes, the oxygen (O₂) permeabilities of the PLS samples were also evaluated (FIG. 3D and FIGS. 17A-17D). PLA showed O₂ permeability of 0.42 barrer (leak error≈8%). All PLS samples exhibited comparable O₂ permeability ≈0.46 barrer (leak error≈7%). In general, PLS displayed comparable thermal, mechanical, and O₂ barrier properties to PLA, demonstrating that statistical incorporation of salicylate sequences into PLA up to 25 mol % does not have a significant impact on these polymer properties.

TABLE 2
Mechanical property data of the polymers

| | Tensile Strength | Elongation at break | Modulus |
|---|---|---|---|
| Sample | (MPa) | (%) | (GPa) |
| PLS7 | 56.4 ± 1.8 | 8.2 ± 0.6 | 1.9 ± 0.0 |
| PLS15 | 58.2 ± 1.3 | 8.0 ± 0.2 | 2.4 ± 0.0 |
| PLS25 | 60.4 ± 0.8 | 7.9 ± 0.2 | 2.4 ± 0.2 |
| PLA | 58.2 ± 0.9 | 7.8 ± 0.5 | 2.0 ± 0.1 |

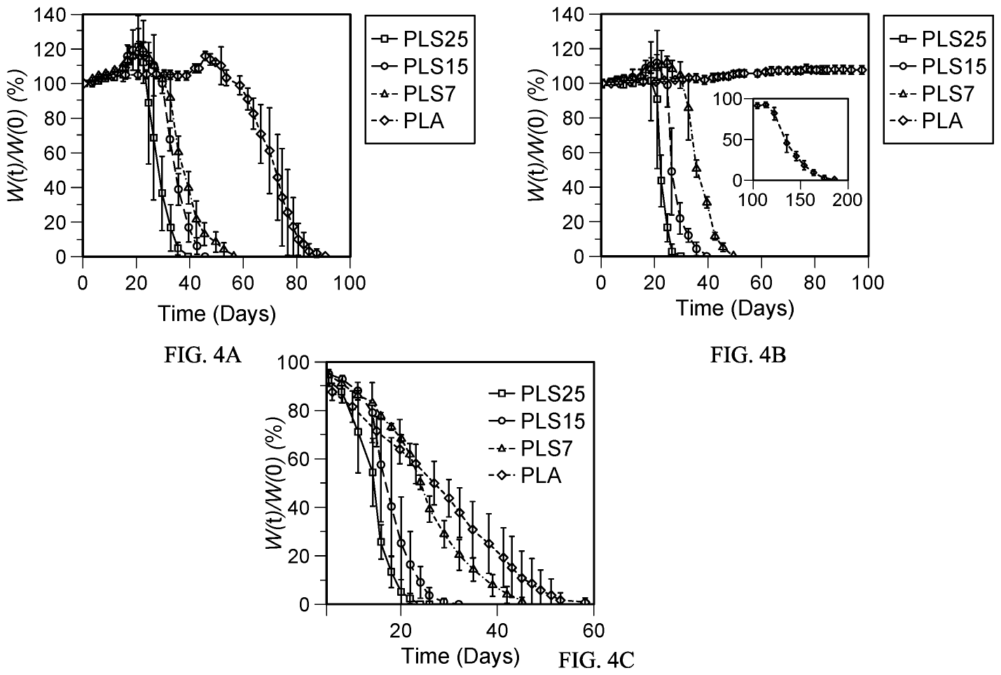

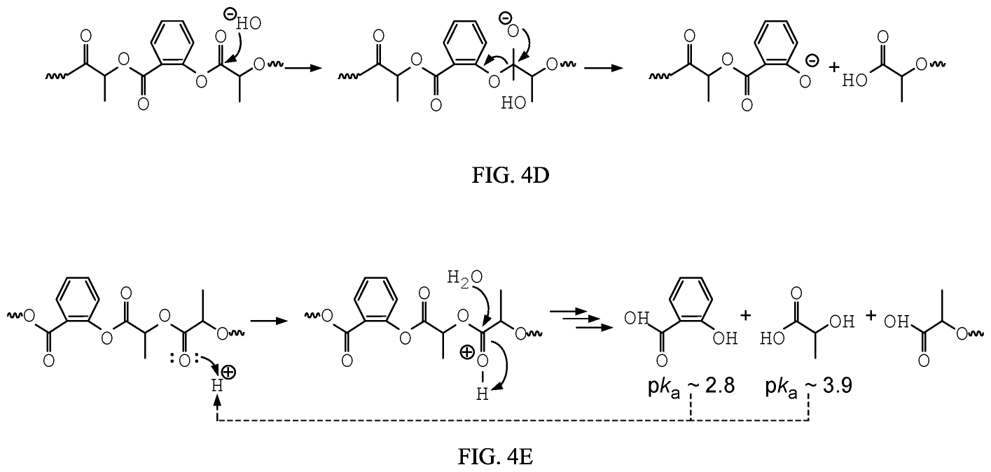

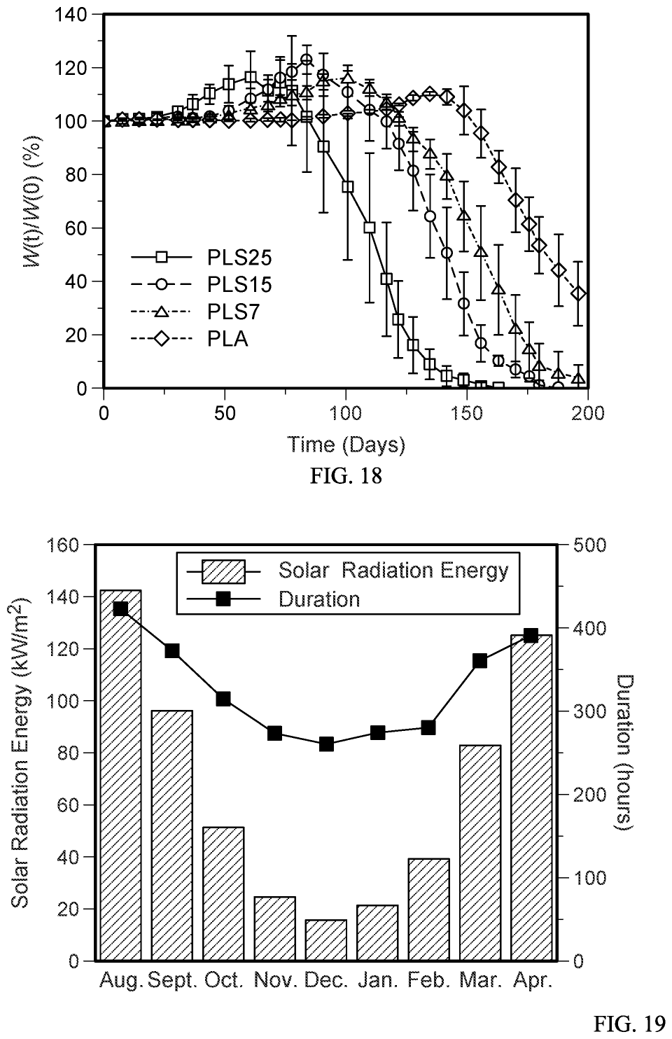

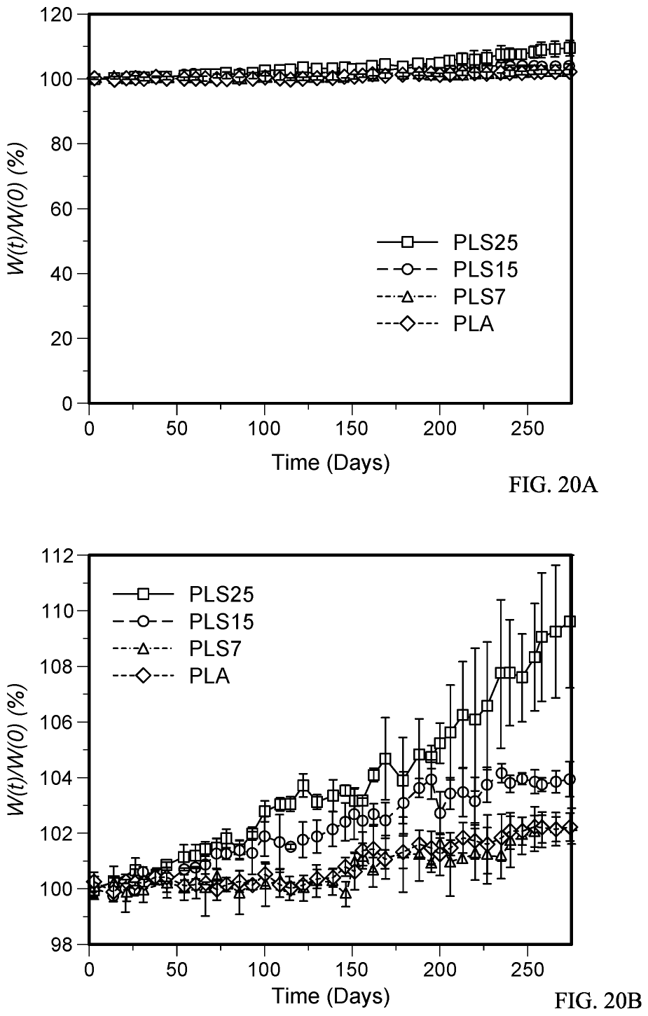

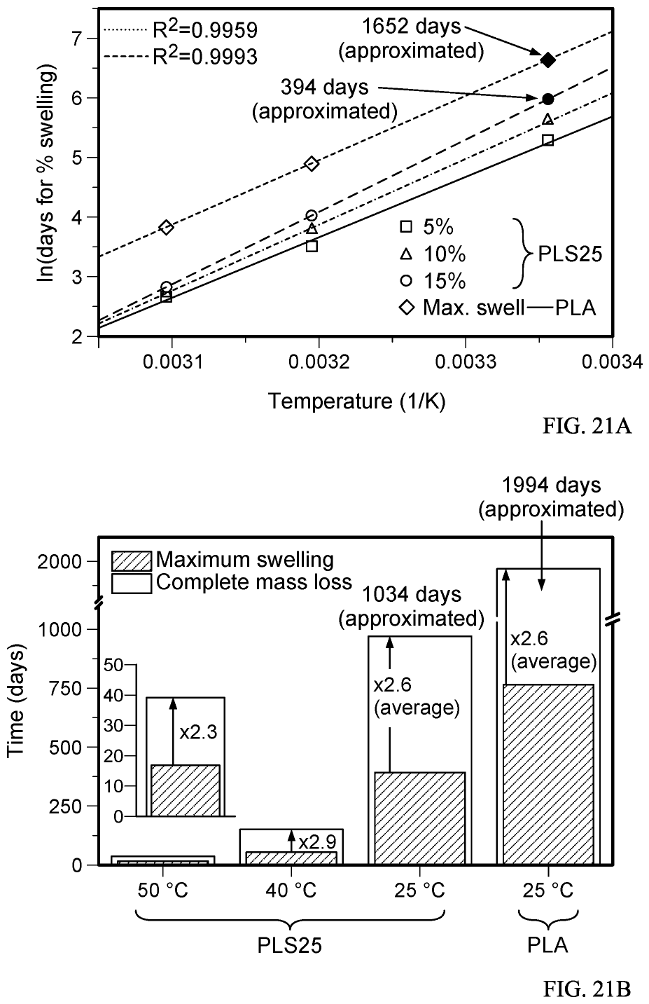

Copolymer hydrolytic degradation. Degradation experiments were performed by immersing the copolymers into aqueous solutions, i.e., phosphate buffer solution (PBS, 1 M, pH 7.4), artificial seawater (pH 8.1), and NaOH solution (0.1 M) (FIGS. 4A-4C). Elevated temperatures (50° C.) allowed us to observe the complete degradation over readily experimentally accessible time frames while remaining below the T_{g} of the samples. Upon immersion in PBS, PLS samples showed complete mass loss after a short induction period (FIGS. 4A-4B). The initial increase in mass during the induction period is attributed to water uptake driven in part by osmotic pressure resulting from a bulk erosion process. PLA also showed complete mass loss, but over a much larger time frame of approximately 90 days as compared to 40-55 days for the PLS samples depending on salicylate content. The accelerative bulk erosive degradation in the PLS samples also occurred in PBS at 40° C. over longer periods (FIG. 18). In addition, degradation experiments in PBS were carried out at room temperature (23-27° C.) with exposure to natural sunlight to mimic natural environmental conditions (FIG. 19). Significant mass increases were observed in the PLS15 and PLS25 samples representing the initial stages of water uptake that were followed by rapid degradation at both 40 and 50° C., but the PLS7 and PLA samples showed no significant mass change (FIGS. 20A-20B). Based on an analysis using the water uptake data at 50, 40, and 23-27° C. and an Arrhenius approach, an estimated 2.8 years is needed for complete degradation of PLS25 in PBS under ambient conditions.

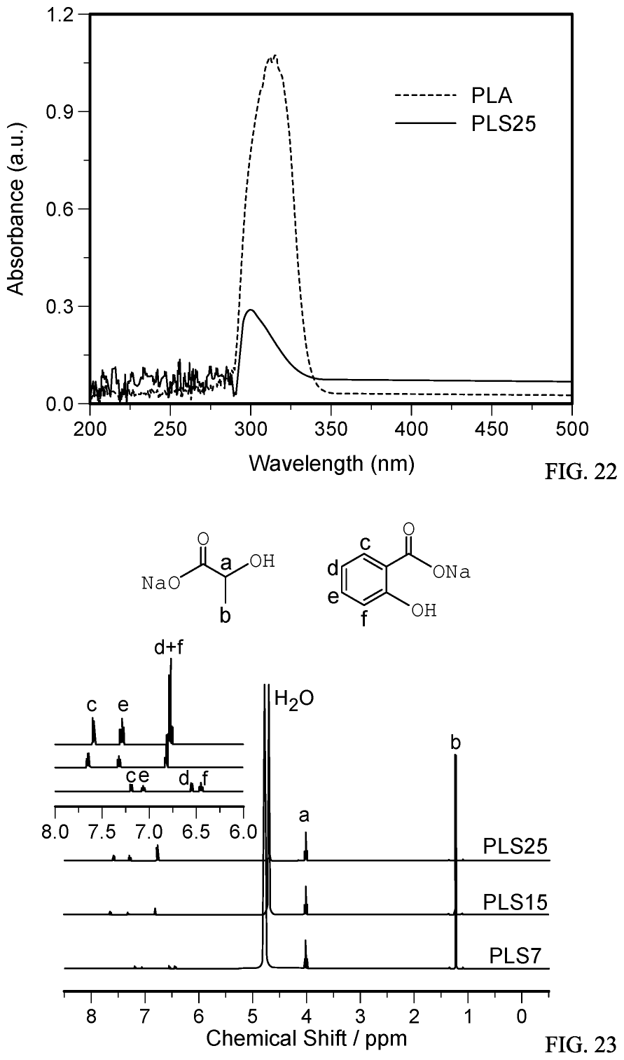

Photo-oxidative processes represent one possible degradation pathway for polyesters including PBAT and PLA in natural environments, suggesting that the aromatic groups could be beneficial for degradation (FIG. 22). PLS displayed even faster bulk erosion in simulated seawater, with complete mass loss of PLS25 over 29 days (FIG. 4B). In contrast, PLA in seawater showed much slower degradation, likely because of weaker ionic strength conditions in simulated seawater that drives water uptake and degradation characteristics. Furthermore, PLS showed faster mass loss profiles in an alkaline solution (0.1 M NaOH) than PLA (FIG. 4C).

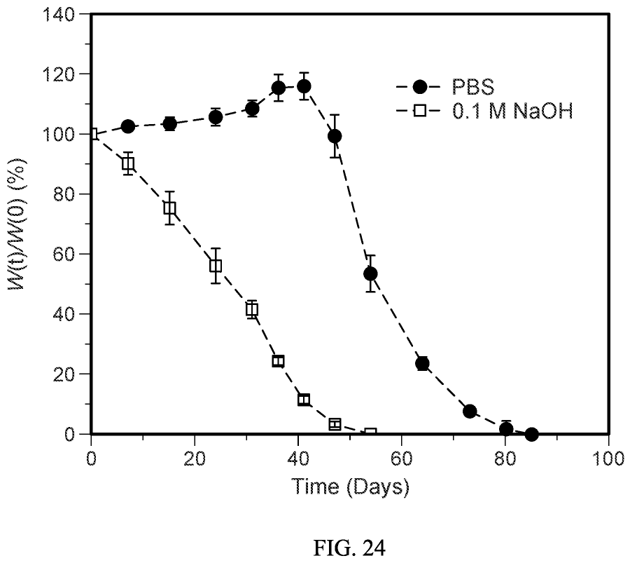

The facile hydrolytic degradation of the PLS samples can be attributed to the salicylate sequences distributed in the polymer backbone. Readily cleavable salicylate moieties facilitate backbone hydrolysis under basic conditions leading to chain fragmentation (FIG. 4D). This is consistent with both the short induction periods of PLS samples under near-neutral conditions (FIGS. 4A-4B and FIG. 18) and faster mass loss profiles of PLS samples as compared to PLA under alkaline condition (FIG. 4C). Salicylic acid, one of the hydrolysis products, can also act as a catalyst for chain cleavage during bulk erosion (FIG. 23 for hydrolysis products). The salicylic acid (pKₐ≈2.8) lower than lactic acid (pKₐ≈3.9), which results in faster generation of other acidic hydrolysis products, leading to an amplified degradation cascade (FIG. 4E). This is consistent with the autocatalytic bulk erosion of PLS samples in PBS and in simulated seawater. PLS2, containing very small amount of salicylate moieties, showed only slightly faster degradation than PLA, possibly due to the small salicylate content and decrease in molar mass, further confirming the role of salicylate moieties for facilitating degradation (FIG. 24). Moreover, the hydrolytic degradation rates of PLS were comparable to PSMG homopolymer in spite of relatively lower salicylate content. This is likely because amorphous PLS (T_{g}≈58-67° C.) is somewhat more mobile at the degradation temperatures as compared to the PSMG (T_{g}≈78-85° C.), enhancing degradation process.

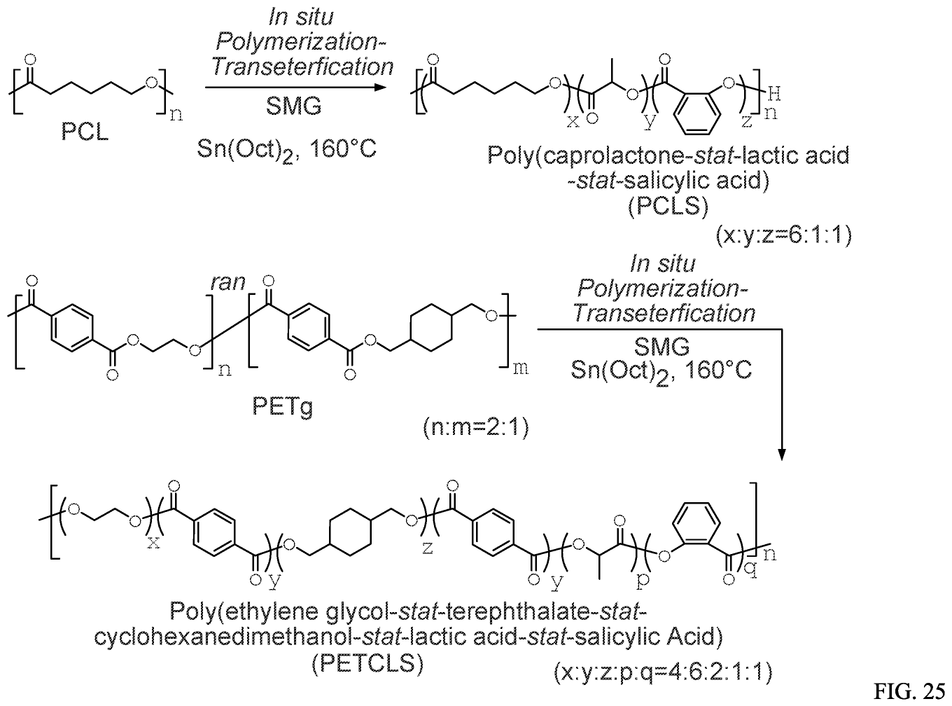

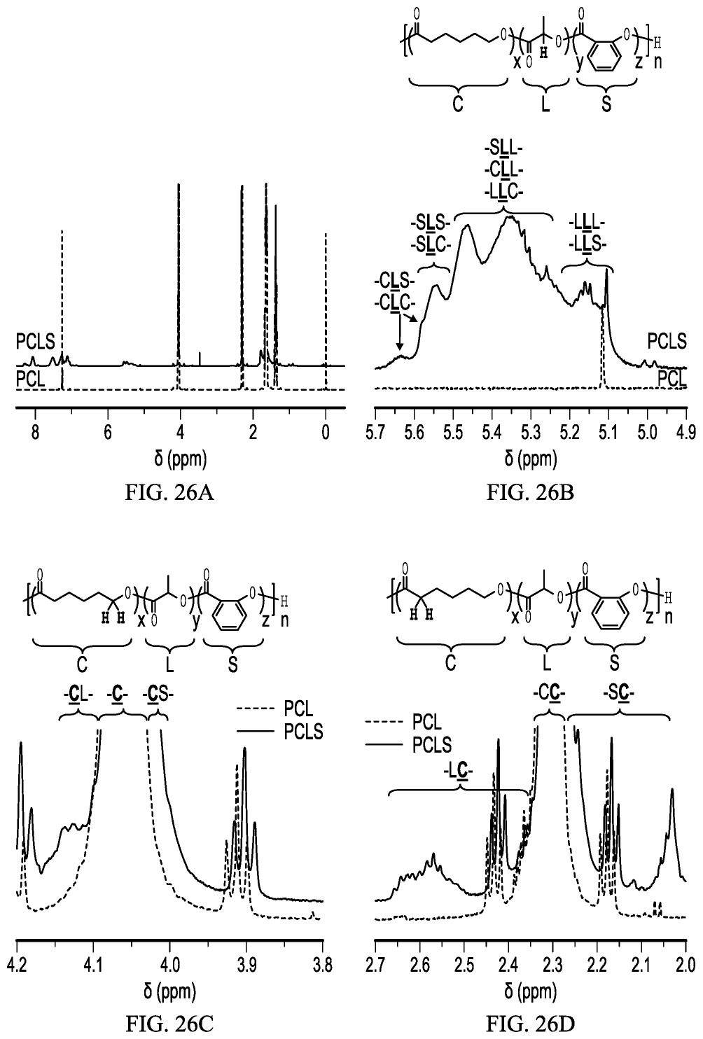

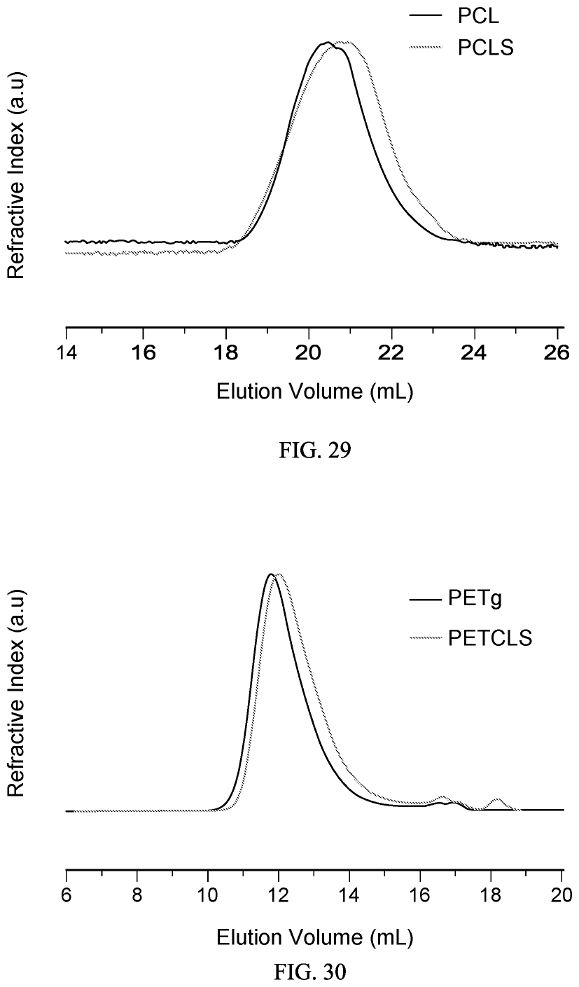

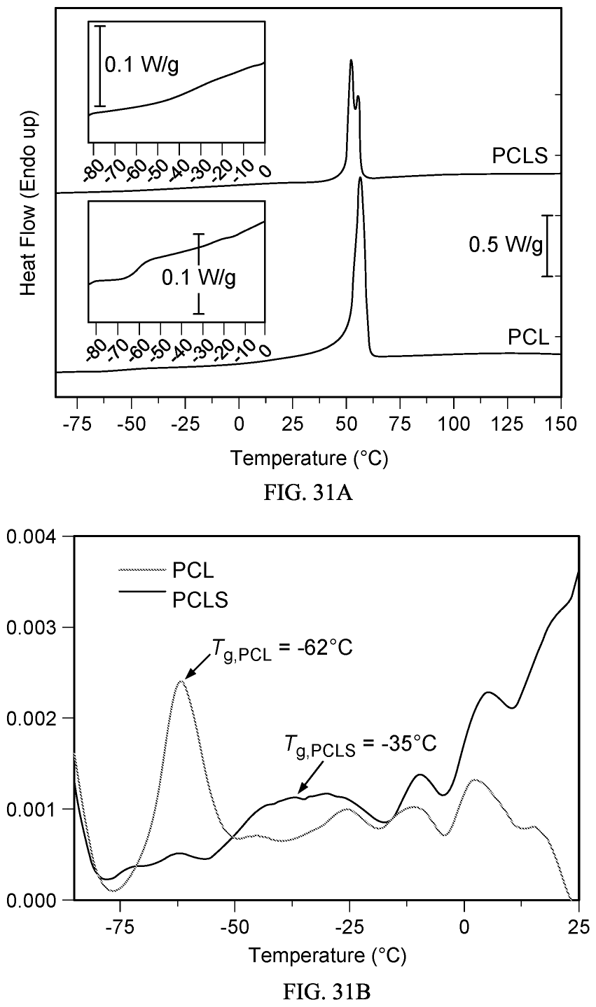

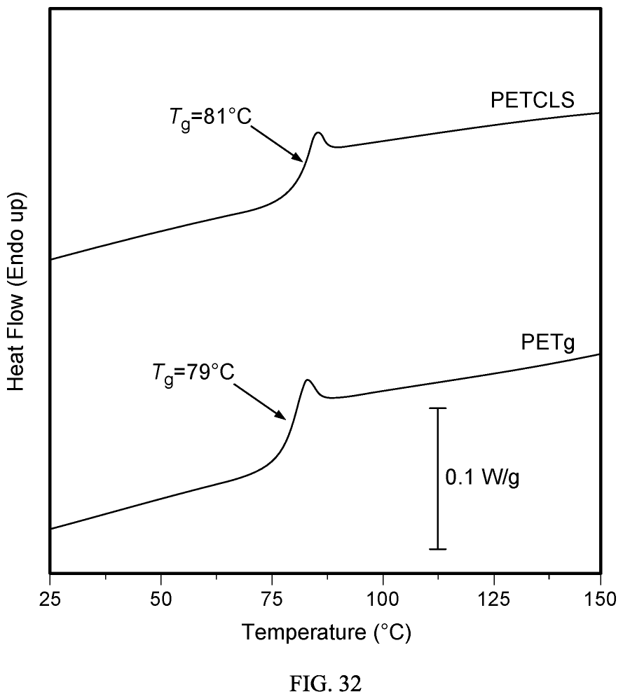

Incorporation of salicylate into other polyesters. To expand the scope of the strategy described above, salicylate moieties were installed into poly(caprolactone) (PCL) and poly(ethylene glycol-co-cyclohexanedimethanol terephthalate) (PETg). PETg, an amorphous derivative of PET, was selected because it has been widely used in many applications (e.g., packaging, bottles) but known to be essentially non-degradable. The copolymers were synthesized by in-situ polymerization-transesterification of SMG and each polymer (Route B, FIG. 25, and Table 3). 1H NMR spectra of poly(caprolactone-stat-lactic acid-stat-salicylic acid) (PCLS) and poly(ethylene glycol-stat-terephthalate-stat-cyclohexanedimethanol-stat-lactic acid-stat-salicylic acid) (PETCLS) showed that salicylate and lactate were incorporated into the polymer backbone in a similar fashion as compared to the PLS (R_{PCL}=0.78, R_{PETCLS}=0.75, FIGS. 26A-26D, 27, and 28A-28D). The successful synthesis was further confirmed by SEC (FIGS. 29-30) and DSC (FIGS. 31A-31B and FIG. 32) analyses.

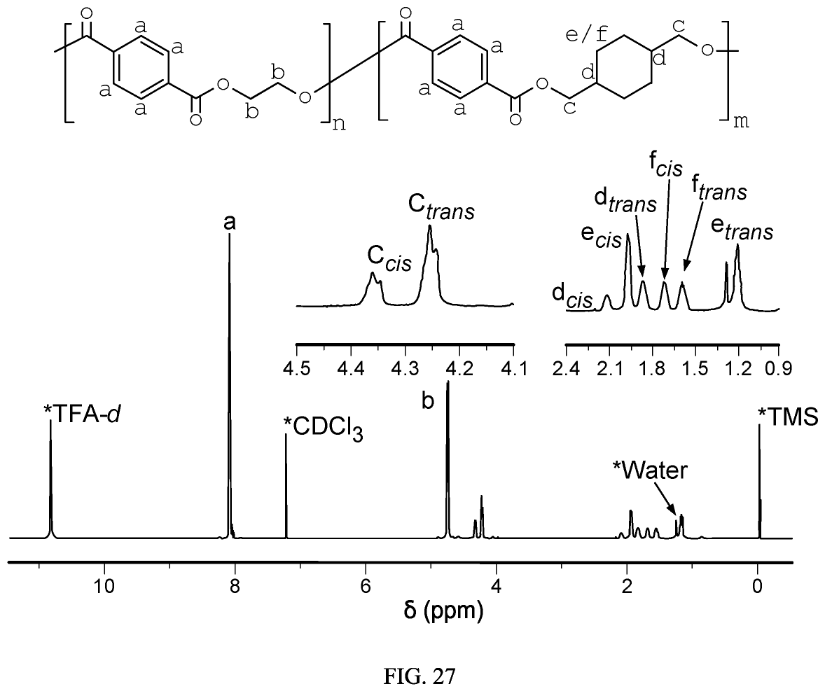

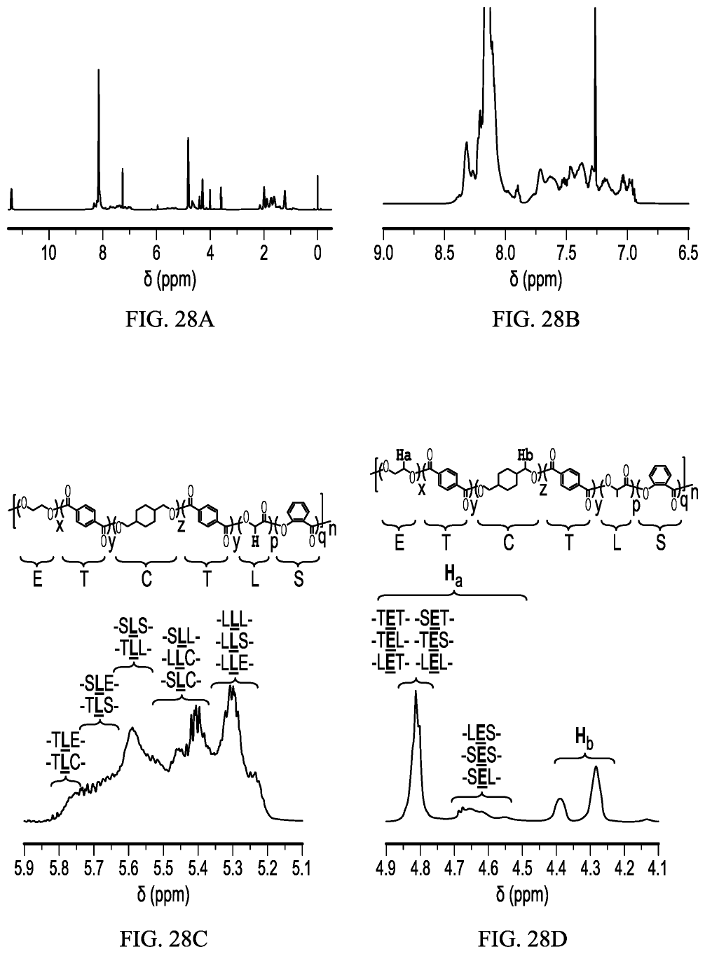

Synthesis of PCL and PETCLS. In-situ polymerization-transesterification of SMG and PCL (or PETg) was performed at 160° C. in presence of Sn(Oct)₂ to yield the modified copolymer containing ≈13 mol % of each salicylate and lactate moieties (Route B). TCE was used for PETCLS because of poor solubility of the parent polymer in common organic solvent. ¹H NMR spectrum of PCLS showed statistical microstructure of the polymer in a similar fashion to the PLS (R=0.78, FIGS. 26A-26D). A number of broad signals were observed at the region corresponding to methine proton, which originate from statistical distributions such as caproyl (C)-L-S, S-L-C, and L-L-C sequences. This is consistent with broadening and the appearance of new resonances in the regions of α- and ε-protons. Similarly, 1H NMR spectrum of PETCLS indicates a statistical microstructure (R=0.75, FIGS. 27 and 28A-28D, Table 3). A number of broad signals were observed in the methine proton region, indicating microstructures such as terephthaloyl (T)-L-ethylene glycol (E), T-L-cyclohexane dimethanol (C), S-L-E, T-L-L, and L-L-E sequences. Multiple peaks appeared in the aromatic region, further confirming the polymer with a statistical microstructure. This is in agreement with broadening of the signals corresponding to methylene protons. Unimodal SEC chromatograms of PCLS and PETCLS indicate the synthesis of a statistical copolymer instead of forming the blend of two homopolymers (FIGS. 29 and 30). DSC data of PCLS supports the statistical copolymer formation. Increases/broadening of the T_{g} and decrease in melting temperature/crystallinity were observed after the installation of salicylate moieties into PCL (FIG. 31A). Note that 1^{st} derivative of the DSC heat curve with respect to temperature was employed to define the T_{g} given that the transition was not clear possibly due to the large endotherm peak and broad transition near T_{g} (FIG. 31B). In contrast, a modest increase in T_{g} was observed when salicylate moieties were incorporated into PETg (FIG. 32), possibly because the two homopolymers, PSMG and PETg, have similar T_{g} values.

TABLE 3
Synthesis and characterization data of PCLS and PETCLS

| | | | SMG | Temperature | SMG | | | | |
|---|---|---|---|---|---|---|---|---|---|
| | | | In feed | (° C.)/ | In polymer | | | | |
| Entry^{a} | Polymer | Route | (mol %)^{b} | Time (h) | (mol %)^{c} | M_{n, SEC}^{d} | M_{w, SEC}^{d} | Ð^{d} | R^{e} |
| 1 | PCLS | B | 13 | 160/20 | 13 | 67 | 95 | 1.4 | 0.78 |
| 2 | PETCLS | B | 13 | 160/20 | 14 | 20 | 51 | 2.6 | 0.75 |

^{a}at [Sn(Oct)₂]₀ = 0.01M in either toluene (run 1) or TCE (run 2) (overall mass concentration, 50 wt %).
^{b}a SMG monomeric unit contains one of each L and S unit.
^{c}Determined by ¹H NMR spectroscopy.
^{d}Determined by either THF-SEC (run 1) or HFIP-SEC (run 2) (molar mass unit, kg mol⁻¹).
^{e}Degree of randomness, determined by ¹H NMR spectroscopy.

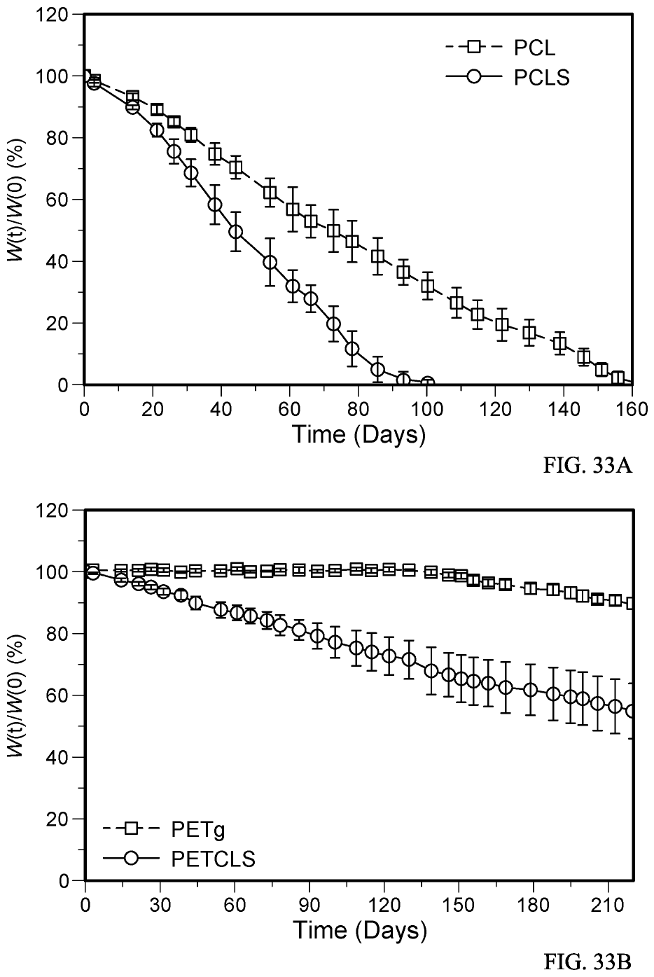

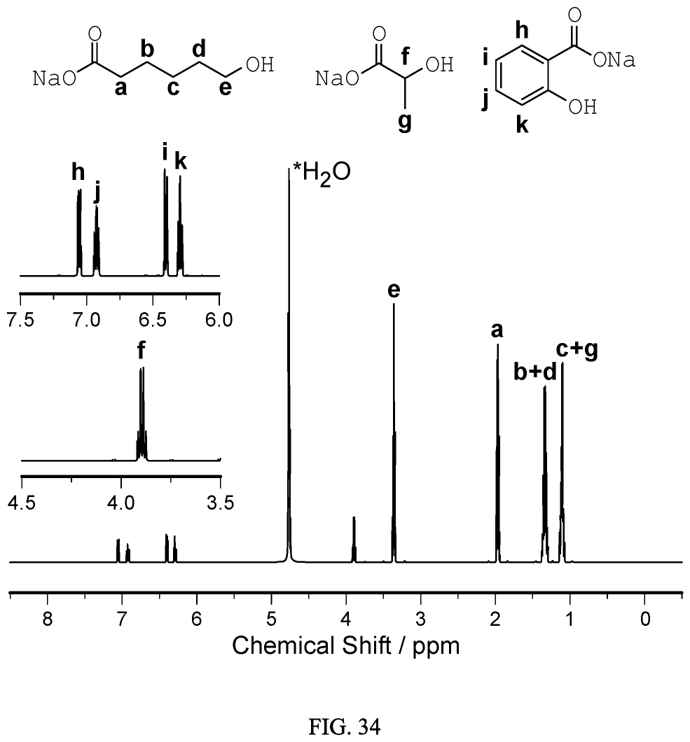

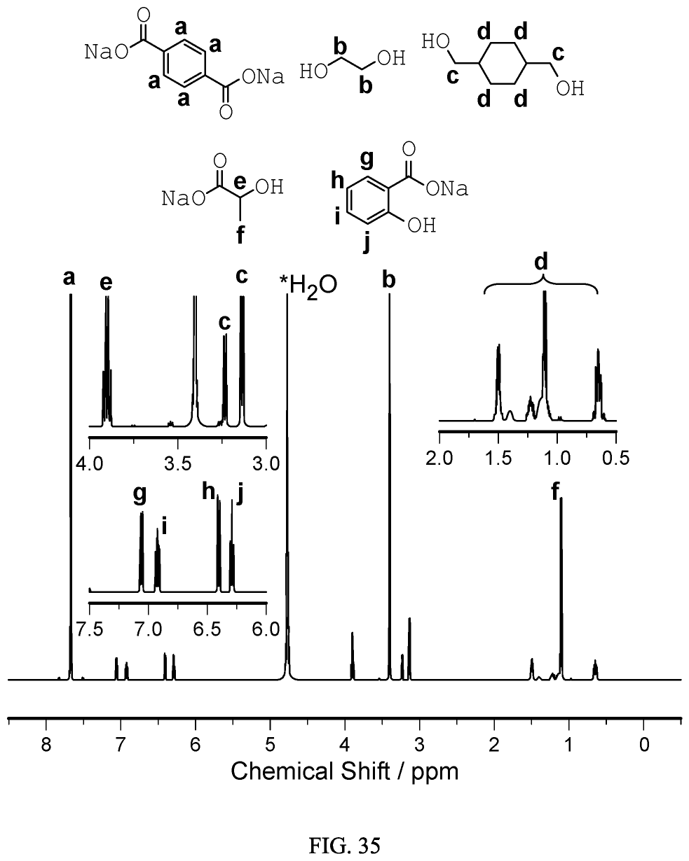

Degradation of PCLS and PETCLS. Degradation experiments were performed by immersing the polymers (i.e., PCL, PCLS, PETg, and PETCLS) into 2 M NaOH aqueous solution at 50° C. (FIGS. 33A-33B). PCL showed slow and continuous mass loss, which is an indicative of surface erosion (FIG. 33A). All triplicate PCL samples completely degraded after 162 days. In contrast, PCLS exhibited faster degradation, the complete degradation over 100 days. Full hydrolysis of PCLS was confirmed by ¹H NMR of the supernatant solution, displaying water soluble acids, i.e., caproic acid, lactic acid, and salicylic acid (FIG. 34). PETg showed slow degradation: no mass loss over 100 days and ≈10% mass loss over 220 days. The mass loss of PETg after 140 days is partially attributed to the insoluble solid particle formation (likely microplastics), which is not counted into weight measurement due to the technical issue. When the insoluble solid was collected after 220 days by a centrifuge, the weight of the dried solid is ≈6% compared to original mass. PETCLS showed enhanced hydrolytic degradation under the same condition: the mass loss reached to ≈45% over 220 days. Given that the composition of lactate and salicylate in PETCLS is ≈23 wt %, mass loss near 45 wt % suggests the partial degradation of the PETg part, i.e., terephthalic acid, ethylene glycol, and cyclohexane dimethanol, which is consistent with the 1H NMR spectrum of the supernatant of degradation solution (FIG. 35).

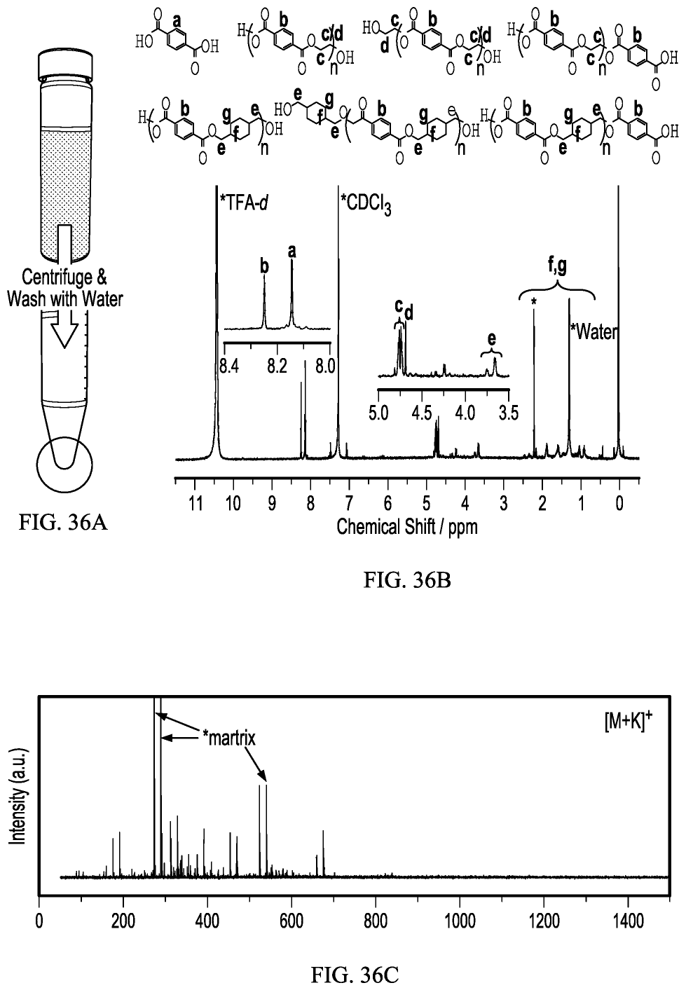

With the mass loss of PETCLS, a small amount of insoluble solid dispersion was produced in the degradation medium of PETCLS. These are possibly water-insoluble mono- or a few-ads esters of terephthalic acid and glycol/cyclohexane dimethanol, which could be produced by chain scissions. To prove this, the dispersion was washed with water and collected by 3× centrifuges (FIG. 36A). Dried solid was soluble in a warm mixture of chloroform and TFA (4:1 wt.). 1H NMR spectrum of the solid suggests that it is possibly composed of mono- or a few-ads of esters (FIG. 36B). This is further supported by MALDI-TOF analysis: the molar mass of the major components is less than 1 kg mol⁻¹ (FIG. 36C). While the insoluble solid was not counted during the weight measurements, the weight was less than 3 wt % compared to original mass. In addition, the insoluble solid became fully soluble when further immersed into the 2 M NaOH aqueous solution at 50° C., likely indicating that PETCLS could completely degrade under the condition over a long period of time.

The facile degradation of PCLS and PETCLS is likely attributed to chain fragmentation by the cleavage of salicylate linkages, thereby producing low molar mass oligomers that degrade easily and/or permeable to water.

### EXPERIMENTAL DETAILS

Materials. Salicylic acid (Millipore-Sigma), 2-bromo propionylbromide (TCI America), sodium bicarbonate (Fisher Scientific), 4-dimethylaminopyridine (DMAP, Millipore-Sigma), Titanium(IV) isopropoxide (Ti(O-iPr)₄, Millipore-Sigma), and acetone (HPLC grade, Fisher Scientific), phosphate buffer solution (1 M, pH 7.4, Millipore-Sigma), artificial seawater (pH 8.1, Millipore-Sigma), and sodium hydroxide (Fisher Scientific) were purchased and used without any purification. 1,5,7-triazabicyclo[4.4.0]dec-5-ene (TBD, Millipore-Sigma) was sublimated two times under vacuum before storing in an argon-filled glove box. 1,8-diazabicyclo[5.4.0]undec-7-ene (DBU, Millipore-Sigma) and 1,1,2,2-tetrachloroethane (TCE, Millipore-Sigma) were distilled under vacuum one time before storing in an argon-filled glove box. n-Octyltin oxide (DOTO, TCI) was dried at 60° C. over 72 h at a reduced pressure prior to use. Tetrahydrofuran (THF) and toluene were passed through a solvent drying system comprising columns of activated alumina and molecular sieves. SnOct₂ (Millipore-Sigma) was distilled three times under vacuum with argon (30-50 mTorr, 130-150° C.) before storing in an argon-filled glove box. Poly(lactide) (PLA, NatureWorks, 4060D) was dissolved in chloroform (≈5 wt %) and precipitated to methanol, followed by drying at 40-50° C. over 72 h at a reduced pressure prior to use. poly(ethylene glycol-co-cyclohexanedimethanol terephthalate) (Eastman Chemical Company, Spectar 14471, ethylene glycol:cyclohexanedimethanol=2.2:1.0, M_{n,SEC}=25 kg mol⁻¹, Ð=2.4) was dried at 50° C. over 24 h at a reduced pressure prior to use. All other chemicals were used as received from Millipore-Sigma unless otherwise specified.

Synthesis of salicylic methyl glycolide (SMG). SMG was synthesized via the reaction between salicylic acid and 2-bromo propionylbromide, followed by a subsequent ring-closure step. 1H NMR (CDCl₃, 500 MHZ): δ 1.66-1.70 (d, 3H), 4.92-4.97 (q, 1H), 7.25-7.28 (d, 1H), 7.40-7.44 (t, 1H), 7.66-7.71 (t, 1H), 7.94-7.97 (d, 1H) (ppm). ¹³C NMR (CDCl₃, 500 MHz): δ 165.85, 165.64, 149.71, 135.58, 132.62, 126.74, 120.85, 120.31, 69.69, 15.69 (ppm). MS-ESI: Mass calculated for C₁₀H₈O₄Na, m/z=215.0320; found, m/z=215.0292.

Copolymerization of lactide and SMG (Route A). Lactide, SMG, BDM, Sn(Oct)₂, and toluene were added to a pressure vessel under an argon atmosphere in a glove box. A Teflon-coated magnetic stir bar was added to the pressure vessel, which was subsequently sealed, taken out of the glove box, and placed in a preheated oil bath. After a certain time, the vessel was opened and cooled in an ice bath to stop the reaction. The crude solution was added dropwise to cold methanol. The precipitated polymer was dissolved in chloroform, and precipitated to cold methanol twice more. The collected polymer was dried under reduced pressure at 40° C. overnight.

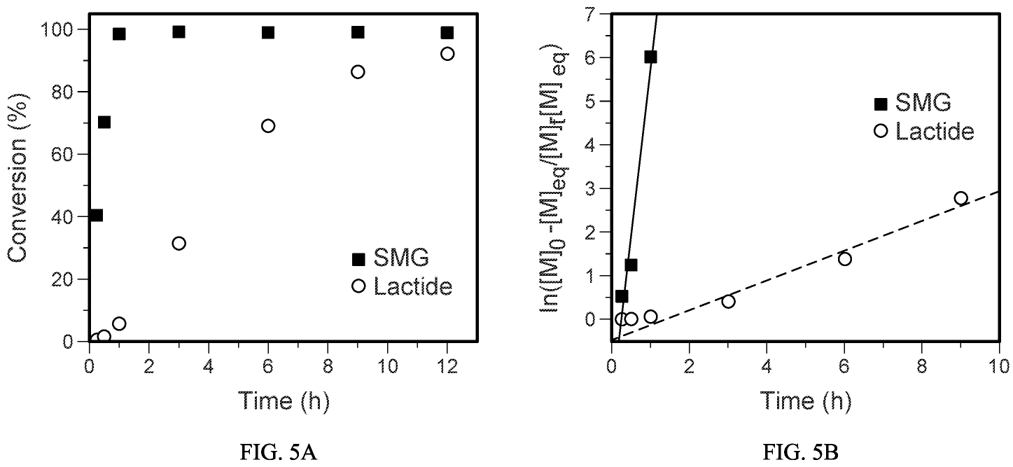

Ring-opening transesterification copolymerization of lactide and SMG was carried out at 110° C., [lactide]₀=1.0 M, [SMG]₀=2.0 M, [benzene dimethanol]₀=0.01 M, [Sn(Oct)₂]₀=0.01 M (See Route A in FIG. 1, Entries 1-4 in Table 1). The copolymerization of a mixture of both cyclic esters produced a poly(salicylic methyl glycolide) (PSMG) homopolymer with very little lactide incorporation after a short reaction time (˜2 h) or a blocky polymer with a longer reaction times (3-12 h). The conversion of SMG was near-quantitative in 1 h, after which most of the lactide was consumed (FIGS. 5A-5B). The thermodynamic parameters of the monomers are: ΔG_{SMG}=−35.4 kcal mol⁻¹ and ΔG_{lactide}=−17.0 kcal mol⁻¹, in bulk at 25° C. In addition, given that ring-opening of SMG generates relatively stable phenolic end groups due to its regio-selectivity, this system is not suitably efficient for the synthesis of a statistical copolymer with salicylate moieties distributed throughout the polymer backbone. The ¹³C NMR spectroscopy results are consistent with the 1H NMR results: S-L-S alternating sequence was prominent at the outset and the signal of L-L-L homosequence appeared over time for the regions of carbonyl-, α-, and β-carbons (FIGS. 6A-6C and 7A-7C). The microstructures of the polymers synthesized through Route A were corroborated by differential scanning calorimetry (DSC) data (FIG. 8). PSMG homopolymer displayed a single T_{g}≈79° C., close to the reported value (78-85° C.), and the blocky polymer showed two distinct T_{g}s≈50, 77° C., indicating block-like microstructure. A unimodal size exclusive chromatography (SEC) chromatogram further indicates the formation of a blocky copolymer instead of forming a mixture of two homopolymers (FIG. 9). The use of other common catalysts for ring-opening transesterification polymerization such as Ti(OiPr)₄, 1,5,7-triazabicyclo[4.4.0]dec-5-ene (TBD), 1,8-diazabicyclo[5.4.0]-undec-7-ene (DBU) yielded similar results.

Transesterification procedures (Routes B and C). Transesterification reactions were performed in either solution or melt. For the reactions in solution, flame-dried 25 mL glass pressure vessel was charged with a predetermined amount of SMG (or PSMG), PLA, Sn(Oct)₂, and toluene. A Teflon-coated magnetic stir bar was added to the pressure vessel, which was subsequently sealed, taken out of the glove box, and placed in a preheated oil bath. After a certain time, the vessel was opened and cooled in an ice bath to stop the reaction. The crude solution was added dropwise to cold methanol. The precipitated polymer was dissolved in chloroform, and precipitated to cold methanol twice more. The collected polymer was dried under reduced pressure at 40° C. overnight. For the transesterification reactions in melt (bulk), PLA, SMG (or PSMG), and DOTO was fed into a recirculating, conical twin-screw batch mixer (DSM Xplore, MC5) operated at ≈100 rpm. DOTO was chosen as a catalyst instead of Sn(Oct)₂ because of its processability (i.e., solid state at room temperature) and stability at ambient conditions. The operating temperature was 160° C. The material was then extruded out after a certain time. The collected material was dissolved in chloroform, and precipitated to cold methanol three times. The precipitated polymer was dried under reduced pressure at 40° C. overnight. For installing salicylate moieties into PCL (or PETg), the same procedure described above was used starting from PCL (or PETg) instead of the PLA. Note that TCE was used as a solvent for the reaction with PETg.

Synthesis of poly(caprolactone) (PCL). PCL was synthesized by a ring-opening transesterification polymerization. ¿-Caprolactone, BDM, and Sn(Oct)₂ were added to a pressure vessel under an argon atmosphere in a glove box. The pressure vessel was placed in a preheated oil bath (130° C.). After 3 h, the vessel was quenched by placing in an ice bath and the crude solution was added dropwise to cold methanol. The precipitated polymer was dissolved in chloroform, and precipitated to cold methanol twice more. The collected polymer was dried under reduced pressure at 30° C. over 72 h prior to use.

Nuclear magnetic resonance (NMR) NMR spectroscopy data were obtained using a 500 MHz Bruker Advance III HD spectrometer with a SampleXpress autosampler (HD-500). All NMR spectra were analyzed using the TopSpin (Bruker).

Differential scanning calorimetry (DSC) DSC analyses were performed using a Mettler Toledo DSC 1 instrument. 5-10 mg of sample was loaded into hermetically sealed aluminum pans for a run. All the samples were run under a gentle nitrogen flow.

Ultraviolet-visible spectroscopy (UV-Vis) UV-Vis spectroscopy data were obtained using a UV/VIS Spectrophotometer instrument (Thermo Evolution 220). Approximately 2 mL of polymer solution (0.1 wt % in THF) loaded into a quartz cuvette cell for a run. All the samples were run at ambient condition.

Thermogravimetric analysis (TGA) TGA analyses were performed on a TA Instruments Q500 at a heating rate of 10° C. min⁻¹ under either nitrogen gas or air flow (40 mL min⁻¹).

Size exclusion chromatography (SEC) For determining the molar mass of PLA, PLS, PCL, and PCLS, SEC was performed in THF (25° C., 1 mL min⁻¹) on an Agilent Infinity 1260 HPLC system equipped with three Waters Styragel HR columns, a Wyatt HELEOS-II multiangle laser light scattering detector, and a Wyatt Optilab T-rEX differential refractive index detector. For determining the molar mass of PETg and PETCLS, SEC was performed in 0.025 M potassium trifluoroacetate (KTFA) solution in HFIP (40° C., 0.35 mL min⁻¹) on a Tosoh EcoSEC SEC system (HLC-8240GPC series liquid chromatograph) equipped with a refractive index detector and two HPLC columns (Tosoh TSKgel SuperAWM-H). Molar masses were determined by conventional calibration vs. poly(methyl methacrylate) (PMMA) standards. Before SEC analyses, the dissolved polymer was filtered through a 0.2 μm filter (Whatman).

Mechanical properties For tensile testing, ATSM D1708 protocol was used. Polymer films were prepared by hot press at 180° C. followed by quenching to ≈50° C. using water cooling. Dog-bone-shaped specimens were punched out from the bubble-free polymer films, resulting in samples with approximately 0.25 mm thickness, 5 mm gauge width, and 20 mm gauge length. Samples were tested to the point of break at the room temperature using Shimadzu Autograph AGS-X Tensile Tester and an extension rate of 5 mm min⁻¹.

O₂ permeation measurement O₂ permeation properties were measured using a constant volume and variable pressure method at 40° C. with ultra-high purity grade O₂ gas was employed. A 1000 psig pressure transducer (Honeywell Sensotec, Model STJE) was used to measure the upstream pressure in the system and a 10 Torr capacitance manometer (MKS, Baratron 626 A) was used to measure the downstream pressure. The downstream pressure was kept below 10 Torr using a vacuum pump prior to measurement. All data were recorded using National Instruments Lab-VIEW software. Permeability, which is an intrinsic property of a specific material to a specific permeate, was expressed in barrer units, where 1 barrer equals to 10⁻¹⁰ cm³ (STP) cm cm⁻² s⁻¹ cmHg⁻¹. The average thickness of the polymer films was 53±9 μm.

Calculation of degree of randomness. The sequence distribution of two repeating units, i.e., salicylate (S) and lactate (L), in copolymers is calculated from the methine proton resonances in ¹H NMR spectra. The integrated peak areas (I) at δ 5.15, 5.26-5.50, and 5.58 associated with LLL, LLS (or SLL), and SLS, respectively, were obtained. The mole fractions (M) of S and L sequences are described as follows:

$${M}_{L} = {I}_{L L S} / 2 + {I}_{LLL} \qquad ( eq . 1 )$$

$${M}_{S} = {I}_{L L S} / 2 + {I}_{SLS} \qquad ( eq . 2 )$$

Therefore, the probability (P) of finding LLS and SLL sequences are predicted as follows:

$${P}_{LLS} = {I}_{L L S} / 2 {M}_{L} \qquad ( eq . 3 )$$

$${P}_{SLL} = {I}_{L L S} / 2 {M}_{S} \qquad ( eq . 4 )$$

The degree of randomness (R) is defined as follows:

$$R = {P}_{L L S} + {P}_{S L L} \qquad ( eq . 5 )$$

where R=0 and 1 indicate block copolymer and completely random copolymer, respectively.

Hydrolytic degradation experiments. 50-100 mg of polymers were compression molded (at 150° C. for 1 min followed by quenching using water cooling). The polymer samples were further dried under vacuum at 130° C. overnight to remove air bubbles inside. The polymer shape was intentionally controlled to be spherical at least in part because the shape of the materials (e.g., size and surface area) is known to play a role in degradation. The spherical polymer chunks of ≈2 mm diameter were subjected to hydrolytic degradation by immersing the samples into 40 mL vials with a stir bar and 35 mL of aqueous solution. A series of an aqueous solution such as 0.1 M or 2 M NaOH solution, 1 M phosphate buffer solution (pH 7.4), and artificial sea water (pH 8.1) was used. For phosphate buffer solution, approximately 0.05 wt % NaN₃ was added to prevent microbial growth. The vials were placed in the crystal bath filled with aluminum beads. Degradation experiments at elevated temperatures (40 and 50° C.) are advantageous, allowing for completion of the degradation experiments for several weeks-several months. The insoluble polymer weight was recorded after removing each sample from the aqueous solution and drying it by Kimwipe™, followed by re-immersing in the same solution. The weight loss values are the averages of measurements on more than two individual samples.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of synthesizing a copolymer, the method comprising:
combining a polyester with an aromatic ester comprising an electron-withdrawing moiety or an electron-donating moiety to yield a mixture; and
transesterifying the aromatic ester and the polyester in the mixture in the presence of a catalyst, thereby inserting at least a portion of the aromatic ester into the polyester backbone to yield the copolymer.

2. The method of claim 1, wherein the polyester comprises a poly(lactic acid), a poly(caprolactone), or a poly(ethylene terephthalate).

3. The method of claim 1, wherein the aromatic ester comprises a salicylate moiety.

4. The method of claim 1, wherein the aromatic ester comprises one or more of salicylic methyl glycolide (SMG), poly(SMG), salicylic acid, a linear polysalicylate, a cyclic salicylate, and a cyclic polysalicylate.

5. The method of claim 1, wherein the catalyst comprises tin.

6. The method of claim 5, wherein the catalyst comprises n-octyltin oxide or stannous octoate.

7. The method of claim 1, wherein the mixture is a melt.

8. The method of claim 1, wherein the mixture comprises a solvent.

9. The method of claim 1, comprising heating the mixture.

10. The method of claim 9, wherein heating the mixture occurs in a twin screw microcompounder.

11. The method of claim 1, wherein the copolymer comprises 0.1 mol % to 50 mol % of salicylate moieties.

12. A copolymer comprising:
a polyester; and
aromatic ester moieties, each having an aryloxy group, inserted along the backbone of the polyester.

13. The copolymer of claim 12, wherein the aromatic ester moieties comprise salicylate moieties.

14. The copolymer of claim 12, wherein the polyester comprises a poly(lactic acid), a poly(caprolactone), or a poly(ethylene terephthalate).

15. The copolymer of claim 14, wherein the polyester comprises a poly(lactic acid), and the copolymer is a poly(lactic acid-stat-salicylic acid) represented by the formula: 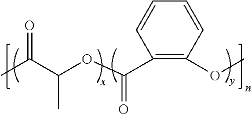
wherein x, y, and n are integers selected such that:
the copolymer comprises 50.5 mol % to 99.5 mol % of the moiety indicated by x and 0.5 mol % to 49.5 mol % of the moiety indicated by y, and
a molecular weight of the copolymer is in a range between 10,000 kg/mol and 200,000 kg/mol.

16. The copolymer of claim 14, wherein the polyester comprises a poly(caprolactone), and the copolymer is a poly(caprolactone-stat-lactic acid-stat-salicylic acid) represented by the formula: 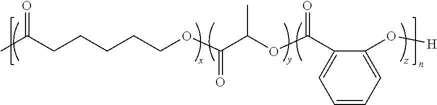
wherein x, y, z, and n are integers selected such that:
the copolymer comprises 0.1 mol % to 99 mol % of the moiety indicated by x, 0.5 mol % to 49.95 mol % of the moiety indicated by y, and 0.5 mol % to 49.95 mol % of the moiety indicated by z, and
a molecular weight of the copolymer is in a range between 10,000 kg/mol and 100,000 kg/mol.

17. The copolymer of claim 14, wherein the polyester comprises a poly(ethylene terephthalate), and the copolymer is a poly(ethylene glycol-stat-terephthalate-stat-cyclohexanedimethanol-stat-lactic acid-stat-salicylic acid) represented by the formula: 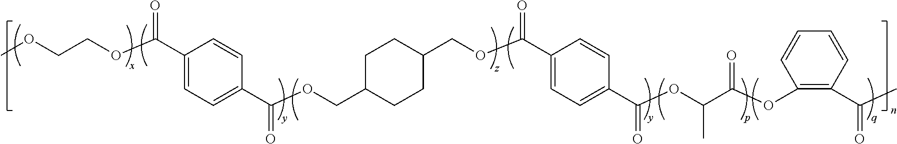
wherein x, y, z, p, q, and n are integers selected such that:
the copolymer comprises 0.1 mol % to 99 mol % of the moiety indicated by y, 0.1 mol % to 99 mol % of the moiety indicated by z, and 0.5 mol % to 49.95 mol % of the moiety indicated by p, 0.5 mol % to 49.95 mol % of the moiety indicated by q, and y=x+z, and
a molecular weight of the copolymer is in a range between 10,000 kg/mol and 50,000 kg/mol.

18. The copolymer of claim 13, wherein the copolymer comprises 0.1 mol % to 50 mol % of the salicylate moieties.

19. The copolymer of claim 12, wherein the copolymer undergoes backbone hydrolysis in aqueous solutions.

20. The copolymer of claim 19, wherein the aromatic ester moieties facilitate the backbone hydrolysis.

21. The copolymer of claim 12, wherein the aromatic ester moieties are distributed throughout the backbone of the polyester.

22. The copolymer of claim 21, wherein the degree of randomness R of the copolymer is between 0 and 2.
